(19) United States
(12) Patent Application Publication
(10) Pub. No.: US 2012/0164903 A1
(43) Pub. Date: Jun. 28, 2012

(54) ARTICLES AND METHODS RELATED TO THE FORMATION OF NANOSTRUCTURE REINFORCED STRUCTURES

(75) Inventors: Brian L. Wardle, Lexington, MA (US); Roberto Guzman de Villoria, Cambridge, MA (US)

(73) Assignee: Massachusetts Institute of Technology, Cambridge, MA (US)

(21) Appl. No.: 13/309,274

(22) Filed: Dec. 1, 2011

Related U.S. Application Data
(60) Provisional application No. 61/418,784, filed on Dec. 1, 2010.

(51) Int. Cl. D03D 15/00; D04H 13/00; D02G 3/02; B32B 5/02; D02G 3/22; B82Y 30/00

(52) U.S. Cl. 442/189; 428/338; 428/401; 442/335; 977/742; 977/762

(57) ABSTRACT

Nanostructure reinforced articles and related systems and methods are generally described.

### RELATED APPLICATIONS

This application claims priority under 35 U.S.C. §119(e) to U.S. Provisional patent application Ser. No. 61/418,784, filed Dec. 1, 2010, and entitled “Articles and Methods Related to the Formation of Nanostructure Reinforced Structures,” which is incorporated herein by reference in its entirety for all purposes.

### TECHNICAL FIELD

Nanostructure reinforced structures and related systems and methods are generally described.

### BACKGROUND

Elongated nanostructures can be used to enhance the structural properties of materials. For example, carbon nanotubes can be used in composites, which are heterogeneous structures comprising two or more components, the combination taking advantage of the individual properties of each component as well as synergistic effects if relevant. Larger scale fibers, such as carbon fibers, have also been used for similar purposes. For example, composites can also be made by arranging larger scale fibers (e.g., carbon fibers) within a binding material. However, many structures including carbon nanotubes and/or larger scale fibers have deficient mechanical, thermal, and/or electrical properties. Accordingly, improved materials and methods are desirable.

### SUMMARY

Articles and methods related to the formation of nanostructure reinforced structures are provided. The subject matter of the present invention involves, in some cases, interrelated products, alternative solutions to a particular problem, and/or a plurality of different uses of one or more systems and/or articles.

In one aspect, articles are provided. In certain embodiments, the article comprises a plurality of fibers, wherein each of the plurality of fibers has a smallest cross-sectional dimension of at least about 1 micrometer, and the plurality of fibers has an average of the smallest cross-sectional dimensions; and a plurality of elongated nanostructures arranged in association with the plurality of fibers to form a cohesive structure, wherein at least a portion of the elongated nanostructures have lengths of at least about 5 times the average of the smallest cross-sectional dimensions of the plurality of fibers.

In some embodiments, the article comprises a plurality of fibers, wherein each of the plurality of fibers has a smallest cross-sectional dimension of at least about 1 micrometer; and a plurality of elongated nanostructures arranged in association with the plurality of fibers to form a cohesive structure such that all ends of at least about 50% of the elongated nanostructures are not in direct contact with any adjacent fibers.

The article comprises, in certain embodiments, a plurality of fibers, wherein each of the plurality of fibers has a smallest cross-sectional dimension of at least about 1 micrometer; and a plurality of elongated nanostructures arranged in association with the plurality of fibers to form a cohesive structure such that the longitudinal axes of at least about 50% of the elongated nanostructures do not intersect any adjacent fibers.

In some embodiments, the article comprises a plurality of fibers, wherein each of the plurality of fibers has a smallest cross-sectional dimension of at least about 1 micrometer; and a plurality of elongated nanostructures arranged in association with the plurality of fibers to form a cohesive structure such that the lengths of the elongated nanostructures span at least 2 fibers.

In certain embodiments, the article comprises a first fiber having a smallest cross-sectional dimension of at least about 1 micrometer; a second fiber having a smallest cross-sectional dimension of at least about 1 micrometer and a second longitudinal axis; and an elongated nanostructure and/or a bundle of elongated nanostructures positioned between the first and second fibers such that the elongated nanostructure and/or assembly of elongated nanostructures are in contact with the first fiber and the second fiber.

In one aspect, a method of making an article is described. The method comprises, in certain embodiments, associating a plurality of fibers and a plurality of elongated nanostructures with each other to form a cohesive structure, wherein each of the plurality of fibers has a smallest cross-sectional dimension of at least about 1 micrometer, the plurality of fibers has an average of the smallest cross-sectional dimensions, and at least a portion of the elongated nanostructures have lengths of at least about 5 times the average of the smallest cross-sectional dimensions of the plurality of fibers.

In some embodiments, the method comprises associating a plurality of fibers and a plurality of elongated nanostructures with each other to form a cohesive structure, wherein each of the plurality of fibers has a smallest cross-sectional dimension of at least about 1 micrometer, and the plurality of elongated nanostructures are arranged between the plurality of fibers such that all ends of at least about 50% of the elongated nanostructures are not in direct contact with any adjacent fibers.

The method comprises, in some embodiments, associating a plurality of fibers and a plurality of elongated nanostructures with each other to form a cohesive structure, wherein each of the plurality of fibers has a smallest cross-sectional dimension of at least about 1 micrometer, and the plurality of elongated nanostructures are arranged between the plurality of fibers such that the longitudinal axes of at least about 50% of the elongated nanostructures do not intersect any adjacent fibers.

In certain embodiments, the method comprises associating a plurality of fibers and a plurality of elongated nanostructures with each other to form a cohesive structure, wherein each of the plurality of fibers has a smallest cross-sectional dimension of at least about 1 micrometer, and the plurality of elongated nanostructures are arranged between the plurality of fibers such that the lengths of the elongated nanostructures span at least 2 fibers.

In some embodiments, the method comprises associating a first fiber, a second fiber, and an elongated nanostructure and/or a bundle of elongated nanostructures with each other to form a cohesive structure, wherein each of the first fiber and the second fiber has a smallest cross-sectional dimension of at least about 1 micrometer, and the elongated nanostructure and/or bundle of elongated nanostructures are positioned between the first and second fibers such that the elongated nanostructure and/or assembly of elongated nanostructures are in contact with the first fiber and the second fiber.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is an exemplary schematic illustration of a portion of an article comprising an arrangement of fibers and elongated nanostructures, according to one set of embodiments;

FIGS. 2A-2B are exemplary perspective and cross-sectional schematic illustrations of a fuzzy fiber composite article;

FIGS. 3A-3C are exemplary schematic illustrations of arrangements of elongated nanostructures and fibers, according to some embodiments;

FIGS. 4A-4B are, according to certain embodiments, schematic illustrations of arrangements of elongated nanostructures and fibers;

FIGS. 5A-5L are schematic illustrations of arrangements of elongated nanostructures and fibers, according to some embodiments;

FIGS. 6A-6D are (A) an exemplary schematic illustration of an assembly of carbon nanotubes and carbon fibers and (B-D) exemplary scanning electron microscrope (SEM) images of a fractured composite comprising a plurality of carbon nanotubes (CNTs) and a plurality of carbon fibers, infused with a polymeric binder;

FIGS. 7A-7F are, according to some embodiments, (A) an exemplary schematic illustration of an assembly of carbon nanotubes and carbon fibers, (B) a photograph of carbon fiber assemblies, (C) a schematic illustration of an electronic testing arrangement and corresponding results, (D) a photograph of a mechanical testing apparatus, (E) exemplary plots of flexural modulus and strength, and (F) exemplary SEM images of fractured composite structures; and

FIGS. 8A-8B are, according to one set of embodiments, (A) a schematic illustration of a resin application apparatus and (B) exemplary SEM images of fractured composite structures.

### DETAILED DESCRIPTION

Nanostructure reinforced structures and related systems and methods are generally described. In some embodiments, a plurality of fibers (e.g., carbon fibers, glass fibers, etc.) can be associated with a plurality of elongated nanostructures (e.g., carbon nanotubes) to form a cohesive structure. In some embodiments, the plurality of fibers can have a first scale (e.g., having smallest cross-sectional dimensions of at least about 1 micrometer) and the elongated nanostructures can have a second, relatively small scale (e.g., having largest cross-sectional diameters of less than about 100 nanometers). The elongated nanostructures can be arranged between and/or around the fibers in a variety of configurations, for example, by stacking, weaving, winding, bending, or otherwise arranging the nanostructures and fibers such that they are associated with each other to form the cohesive structure. In some embodiments, the fibers and elongated nanostructures can be arranged such that they form 3-dimensional architectures. For example, elongated nanostructures can be incorporated into the spaces between collimated or woven fibers to form composite tows, laminae, and/or laminates. In some embodiments, a binding material (e.g., a polymeric material such as an epoxy) can be added to the cohesive structure to form, for example, a composite material. The plurality of nanostructures and/or fibers (and/or sub-portions of the plurality of nanostructures and fibers) may be provided such that their longitudinal axes are substantially aligned and, in some cases, continuous from end to end of the sample.

The elongated nanostructures can be arranged such that all ends of a majority of the nanostructures are not in direct contact with any adjacent fibers. In some cases, the elongated nanostructures can be arranged such that the longitudinal axes of a majority of the nanostructures do not intersect any adjacent fibers.

The presence of the elongated nanostructures can impart advantageous mechanical, thermal, and/or electrical properties to and/or enhance the mechanical, thermal, and/or electrical properties of the cohesive structure, relative to the mechanical, thermal, and/or electrical properties that would be observed in the absence of the nanostructures but under otherwise essentially identical conditions. For example, incorporating elongated nanostructures into the cohesive structure might enhance the fracture toughness, yield strength, electrical conductivity, and/or thermal conductivity of the cohesive structure.

Advantageously, the elongated nanostructures within the articles described herein can be relatively long, e.g., as measured relative to the thicknesses of fibers, plies, and/or laminates within the structure. For example, in some embodiments, one or more of the elongated nanostructures can have a length of at least about 5 times the average of the smallest cross-sectional dimensions of the plurality of fibers within the article. In some embodiments, elongated nanostructures can be wrapped around fibers and/or groups of fibers, and/or can extend through groups of fibers. The elongated nanostructures, in certain embodiments, do not extend radially from the fibers within the composite article, as might be observed, for example, in a fuzzy-fiber where elongated nanostructures are grown from the surface of a fiber.

In some embodiments, the elongated nanostructures and the fibers can be produced separately and assembled to form the article (e.g., a composite article) under relatively benign conditions (e.g., at room temperature and/or pressure). Thus, in some such embodiments, the conditions under which the elongated nanostructures are grown, under which fibers are formed, and/or under which binding materials are added (which can include, for example, exposure to high temperatures, reactive chemicals, high pressures, and the like) do not impact the structural integrity of the nanostructures, fibers, and/or binding material. The various architectures described herein can also be realized using processes consistent with many forms of advanced composite processing such as prepregging, tape-pregging, tow spreading, infusion, resin transfer molding (RTM), hand lay-up, resin film infusion (RFI), and the like. The fibers and elongated nanostructures described herein can also be assembled such that their spacing is specifically tailored, for example, to selectively reinforce specific regions within the assembled article (e.g., a composite article).

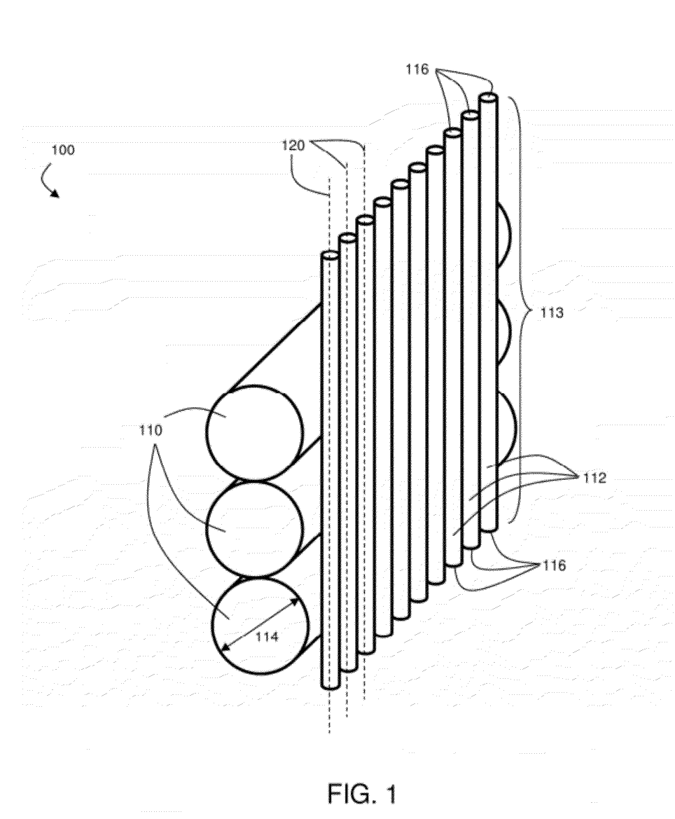

FIG. 1 is an exemplary schematic illustration of a portion 100 of an article comprising an arrangement of fibers 110 and elongated nanostructures 112. It should be understood that, in all of the embodiments described herein, wherever single fibers and single elongated nanostructures are described or illustrated in the figures, any single fiber can be replaced by bundles of fibers and/or any single elongated nanostructure can be replaced by bundles of elongated nanostructures. That is to say, single fibers, and/or bundles of fibers (including strips of fibers, tows of fibers, yarns of fibers, and the like) can all be interchanged; and/or single nanostructures and/or bundles of nanostructures (including strips of nanostructures, tows of nanostructures, yarns of nanostructures, and the like) can all be interchanged, depending on the particular application. For example, referring to FIG. 1, in some embodiments, any of fibers 110 can be replaced with a bundle of fibers (e.g., tens of fibers, hundreds of fibers, thousands of fibers, etc.), which can be arranged in a tow, a strip, a yarn, or any other suitable configuration. In some embodiments, any of elongated nanostructures 112 can be replaced with a bundle of elongated nanostructures (e.g., tens of elongated nanostructures, hundreds of nanostructures, thousands of nanostructures, etc.) which can be arranged in a tow, a strip, a yarn, or any other suitable configuration.

Generally, a bundle of objects (e.g., elongated nanostructures, fibers) includes a plurality of the objects arranged with each other such that they are in contact with at least one other member of the bundle, with or without auxiliary adhesive, i.e., without an adhesive that would not be inherently present in or on the objects of the bundle. In certain embodiments, the bundle of objects can itself form a cohesive structure. For example, in certain embodiments, a bundle of elongated nanostructures can include a plurality of nanostructures that are entangled with each other (e.g., and, optionally, having longitudinal axes that are substantially aligned with each other) such that the plurality of nanostructures forms a cohesive structure. As another example, a bundle of fibers can include a plurality of fibers that are entangled with each other such that they form a cohesive structure. Specific examples of bundles of objects include, but are not limited to, strips, tows, yarns, and the like. In certain embodiments in which elongated structures form the bundle, the elongated structures within the bundle can be in contact with at least one other elongated structure in the bundle along substantially the entire lengths of the longitudinal axes of the elongated structures within the bundle. For example, in some embodiments, the bundle comprises a tow of elongated nanostructures arranged such that the nanostructures extend from one end of the tow to the other, and each of the nanostructures is in contact with at least one other nanostructure within the tow. Similarly, the bundle could comprise a tow of fibers arranged such that the fibers extend from one end of the tow to the other, and each of the fibers is in contact with at least one other fiber within the tow.

In certain embodiments, a bundle of objects (e.g., elongated nanostructures, fibers) can be arranged in a strip. Generally, a strip includes a relatively thin thickness and a relatively long length and width. In certain embodiments, a strip of elongated nanostructures or fibers can include a thickness, a first dimension orthogonal to the thickness, and the second dimension orthogonal to the thickness and the first dimension, wherein the first and second dimensions are at least about five times, at least about 10 times, at least about 50 times, or at least about 100 times longer than the thickness. In certain embodiments, at least one of the first and second dimensions is at least about 50 times, at least about 100 times, at least about 500 times, or at least about 1000 times longer than the thickness of the strip. In certain embodiments, the components (e.g., elongated nanostructures or fibers) within the strip can be substantially aligned along a direction of the strip. For example, in certain embodiments, elongated nanostructures or fibers can be substantially aligned along the longest dimension of the strip, or they can be substantially aligned along a dimension orthogonal to the thickness and the longest dimension of the strip.

A bundle of objects (e.g., elongated nanostructures, fibers) can also be arranged in a tow or a yarn, in certain embodiments. Generally, a tow refers to a bundle in which a plurality of substantially continuous filaments (e.g., elongated nanostructures or fibers arranged side by side) are arranged to form an elongated bundle. Generally, a yarn refers to a bundle in which a plurality of substantially discontinuous filaments (e.g., elongated nanostructures or fibers that are arranged side by side and/or end to end) are arranged to form an elongated bundle. The discontinuous filaments within a yarn can be held together in a cohesive structure, for example, by twisting or otherwise entangling the discontinuous filaments. The longitudinal axes of the filaments within a tow and/or a yarn can be arranged such that they are substantially parallel to the length of the tow and/or the yarn.

In certain embodiments, a tow and/or a yarn can be configured such that it has a relatively long length in one direction and is relatively short in directions orthogonal to length. For example, in certain embodiments, a tow and/or a yarn can have a length that is at least about 10 times, at least about 50 times, at least about 100 times, or least about 1000 times the maximum cross-sectional dimension of the tow and/or yarn. In certain embodiments, yarns and/or tows of fibers and/or elongated nanostructures can be woven, stacked, or otherwise assembled to form fabrics such as woven or non-woven fabrics. In some such embodiments, fibers (e.g., single fibers and/or bundles of fibers) can be assembled to form a fabric, and elongated nanostructures (e.g., single elongated nanostructures and/or bundles of elongated nanostructures) can be positioned among and between the fibers to provide structural support and/or enhanced electrical conductivity.

In certain embodiments, the elongated nanostructures and the fibers can be arranged in association with each other such that they form a cohesive structure. Generally, cohesive structures are structures that can be bent, moved, or otherwise manipulated without falling apart. For example, fibers and elongated nanostructures can form a cohesive structure when they are spatially arranged relative to each other such that the fibers and/or nanostructures do not substantially disassociate from each other when the structure is bent, moved, or otherwise manipulated. In some embodiments, components (e.g., fibers and/or elongated nanostructures) of a cohesive structure can be held together by weaving, entanglement, or otherwise arranging the components such that frictional forces keep them together. The components of a cohesive structure can be held together by forces stronger than van der Waals forces, in certain embodiments. For example, in some embodiments, the components of the cohesive structure can be held together by covalent bonds and/or by adhesive forces (e.g., using a binder). While the elongated nanostructures illustrated in FIG. 1 are shown as being completely aligned without entanglement, the longitudinal axes of the elongated nanostructures could be entangled in certain embodiments. In addition, while the fibers illustrated in FIG. 1 are not entangled, the longitudinal axes of the fibers could be entangled in certain embodiments.

In some embodiments, the elongated nanostructures are in direct contact with the fibers, while in other embodiments, one or more materials can be positioned between the elongated nanostructures and the fibers. For example, in certain embodiments, the elongated nanostructures and the fibers can be in direct contact such that the nanostructures tangentially contact the fibers, as illustrated in FIG. 1. In other embodiments, a binding material can be positioned between the elongated nanostructures and the fibers. For example, the fibers can be part of a prepreg material, in which case a binding material within the prepreg can be positioned between the elongated nanostructures and the fibers. In certain embodiments, a relatively large number of the elongated nanostructures (e.g., at least about 50%, at least about 75%, at least about 90%, at least about 95%, at least about 99%, or substantially all of the elongated nanostructures) within a cohesive structure can be positioned such that the shortest distance between the nanostructure and a fiber is less than about 10 times, less than about 5 times, or less than about 2 times the average of the smallest cross-sectional dimensions of the fibers within the structure.

The fibers described herein can comprise elongated structures with aspect ratios of at least about 5:1, at least about 10:1, at least about 50:1, at least about 100:1, at least about 1000:1, or larger. The fibers can be made out of a variety of suitable materials. For example, in certain embodiments, the fibers comprise carbon, a polymer, an aluminum oxide, a silicon oxide, a cellulosic material, basalt, and/or a metal. The fibers described herein can have relatively large cross-sectional dimensions. In some embodiments, each of the plurality of fibers within an article can have a smallest cross-sectional dimension of at least about 1 micrometer, at least about 5 micrometers, or at least about 10 micrometers. As used herein, the “smallest cross-sectional dimension” of a structure refers to the smallest distance between two opposed boundaries of an individual structure that may be measured. In some embodiments, the average of the smallest cross-sectional dimensions of the plurality of fibers can be at least about 1 micrometer, at least about 5 micrometers, or at least about 10 micrometers. The “average of the smallest cross-sectional dimensions” of a plurality of structures refers to the number average.

As used herein, the term “elongated nanostructure” refers to elongated chemical structures having a diameter less than about 100 nanometers and a length resulting in an aspect ratio greater than about 10, greater than about 100, greater than about 1000, greater than about 10,000, or greater. One of ordinary skill in the art would recognize that elongated nanostructures can be single molecules (e.g., in the case of some nanotubes) or can include multiple molecules bound to each other (e.g., in the case of some nanofibers). In some cases, the elongated nanostructure may have a maximum cross-sectional diameter of less than about 100 nm, less than about 50 nm, less than about 25 nm, less than about 10 nm, or, in some cases, less than about 1 nm. A “maximum cross-sectional diameter” of an elongated nanostructure, as used herein, refers to the largest diameter between two points on opposed outer boundaries of the elongated nanostructure, as measured perpendicular to the length of the elongated nanostructure (e.g., the length of a carbon nanotube). The “average of the maximum cross-sectional diameters” of a plurality of structures refers to the number average. The elongated nanostructure can have a cylindrical or pseudo-cylindrical shape. In some embodiments, the elongated nanostructure can be a nanotube, such as a carbon nanotube. Other examples of elongated nanostructures include, but are not limited to, nanofibers and nanowires.

In the set of embodiments illustrated in FIG. 1, the plurality of fibers have relatively large cross-sectional dimensions, compared to the cross-sectional dimensions of the elongated nanostructures. In some embodiments, the fibers described herein can have smallest cross-sectional dimensions that are at least about 10 times, at least about 50 times, or at least about 100 times larger than the maximum cross-sectional diameters of the elongated nanostructures within the assembled article.

In some embodiments, the elongated nanostructures can be relatively long, for example, relative to the smallest cross-sectional dimensions of the fibers. Referring back to the set of embodiments illustrated in FIG. 1, the lengths 113 of elongated nanostructures 112 can be substantially longer than the smallest cross-sectional dimension of the fibers (illustrated as dimension 114 for the bottom fiber). In some embodiments, at least a portion of the elongated nanostructures can have a length of at least about 5 times, at least about 10 times, at least about 50 times, at least about 100 times, at least about 500 times, or at least about 1000 times the average of the smallest cross-sectional dimensions of the plurality of fibers (and, in certain embodiments, lengths of less than about 10¹⁵ times the average of the smallest cross-sectional dimensions of the plurality of fibers). In some embodiments, at least about 25%, at least about 50%, at least about 75%, at least about 90%, at least about 95%, at least about 99%, or substantially all of the elongated nanostructures within a structure can have a length of at least about 5 times, at least about 10 times, at least about 50 times, at least about 100 times, at least about 500 times, or at least about 1000 times the average of the smallest cross-sectional dimensions of the plurality of fibers (and, in certain embodiments, lengths of less than about 10¹⁵ times the average of the smallest cross-sectional dimensions of the plurality of fibers). In some cases, relatively short elongated nanostructures can be included in the articles described herein. For example, in some embodiments, the articles can include elongated nanostructures with lengths that are less than about 5 times, less than about 2 times, less than about 1 time, or less than about 0.5 times the average of the smallest cross-sectional dimensions of the plurality of fibers. As a specific example, in some embodiments, the articles or structures described herein can include a mix of relatively long elongated nanostructures (e.g., having any distribution of lengths described elsewhere) and relatively short elongated nanostructures (e.g., having any distribution of lengths described elsewhere).

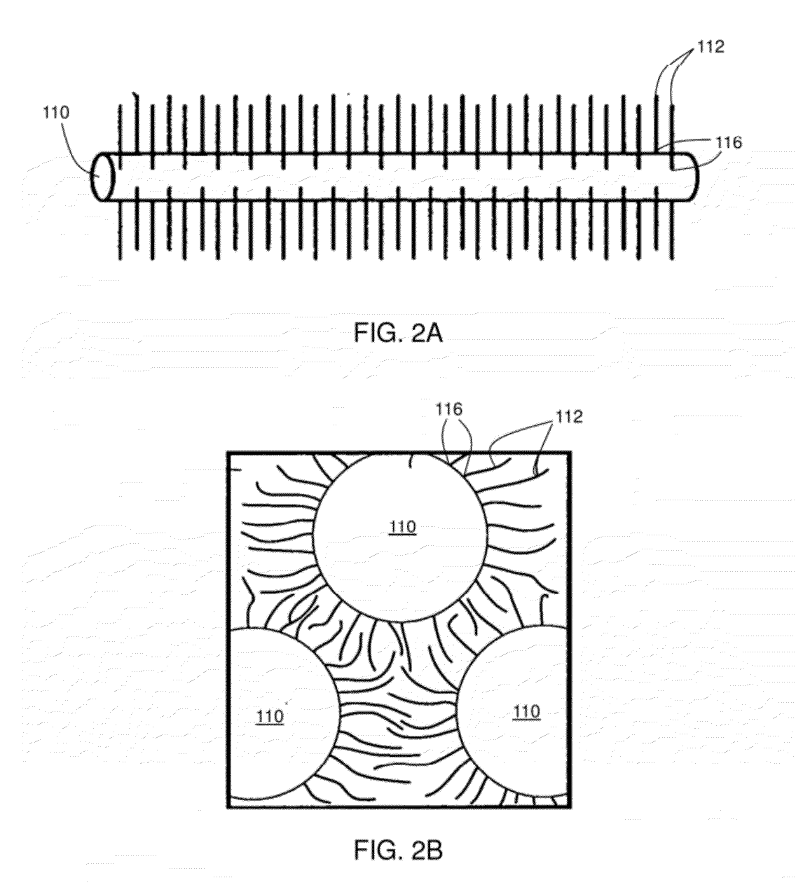

In some embodiments, the elongated nanostructures can be arranged within the article such that they do not extend radially outward from the fibers, as might be observed in “fuzzy fiber” composite articles such as those illustrated in FIG. 2A (a perspective-view schematic illustration) and FIG. 2B (a cross-sectional schematic illustration). By orienting the elongated nanostructures such that they do not extend radially outward from the fibers, relatively long elongated nanostructures can be used. In addition, the elongated nanostructures can assume a wide variety of positions relative to those that can be achieved when the elongated nanostructures extend radially outward from the fibers.

In some embodiments, the plurality of elongated nanostructures within an article can be arranged such that all ends of at least about 50%, at least about 60%, at least about 70%, at least about 80%, at least about 90%, at least about 95%, at least about 99%, or substantially all of the elongated nanostructures are not in direct contact with any adjacent fibers. For example, in the set of embodiments illustrated in FIG. 1, elongated nanostructures 112 include two ends 116, and each of ends 116 of each of elongated nanostructures 112 are not in direct contact with any of fibers 110. In contrast, in FIG. 2B, ends 116 of nanostructures 112 are in contact with fibers 110. In certain embodiments in which the elongated nanostructures comprise more than two ends (e.g., three ends in the case of an elongated nanostructure in which one of the terminal portions is bifurcated), each of the more than two ends can be free of contact with fibers.

In some embodiments, the elongated nanostructures can be arranged such that their longitudinal axes do not intersect adjacent fibers within the article. As used herein, a “longitudinal axis” refers to an imaginary line that includes the geometric center of the cross-section of the base of the elongated nanostructure and the geometric center of the cross-section of the tip of the elongated nanostructure, and continues beyond the ends of the elongated nanostructure in a direction corresponding to the tangent of the curvature of the elongated nanostructure at its end. For example, in the set of embodiments illustrated in FIG. 1, elongated nanostructures 112 include longitudinal axes 120 (illustrated as dotted lines). One of ordinary skill in the art would understand the term geometric center and how to measure the geometric center of the cross-sections of the base and the tip of a elongated nanostructure.

In some embodiments, the plurality of elongated nanostructures within an article can be arranged such longitudinal axes of at least about 50%, at least about 60%, at least about 70%, at least about 80%, at least about 90%, at least about 95%, at least about 99%, or substantially all of the elongated nanostructures do not intersect any adjacent fibers.

In some embodiments, at least about 50%, at least about 60%, at least about 70%, at least about 80%, at least about 90%, at least about 95%, at least about 99%, or substantially all of the elongated nanostructures within the article or structure include longitudinal axes arranged such that the majority of the length of the longitudinal axis (e.g., at least about 50%, at least about 75%, at least about 90%, at least about 95%, or at least about 99% of the length of the longitudinal axis within the nanostructure) is tangential to the fibers with which the elongated nanostructure is in closest proximity (e.g., in contact with). I.e., in this embodiment, the longitudinal axes of this set of nanostructures do not intersect fibers in closest proximity. For example, in the set of embodiments illustrated in FIG. 1, each of elongated nanostructures 112 includes a longitudinal axis 120 that, along its entire length, is tangential to fibers 110 (with which nanostructures 112 are in contact). In contrast, in FIGS. 2A-2B, each of nanostructures 112 includes a longitudinal axis that intersects at least one fiber 110; each of nanostructures 112 includes one end in contact with a fiber (resulting in a first intersection between the longitudinal axis of the elongated nanostructure and a first fiber), and in many cases, the nanostructures include opposite ends that are pointed toward the bulk of another fiber (resulting in a second intersection between the longitudinal axis of the elongated nanostructure and a second fiber). Thus, none of elongated nanostructures 112 in FIGS. 2A-2B are tangential to fibers 110.

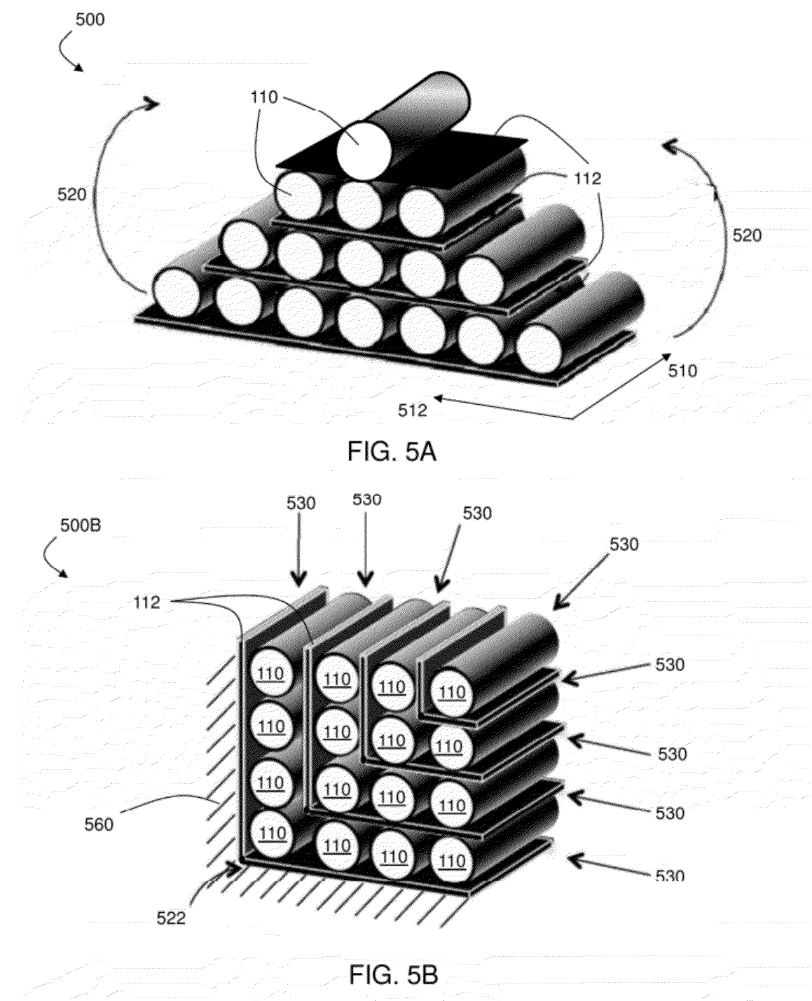

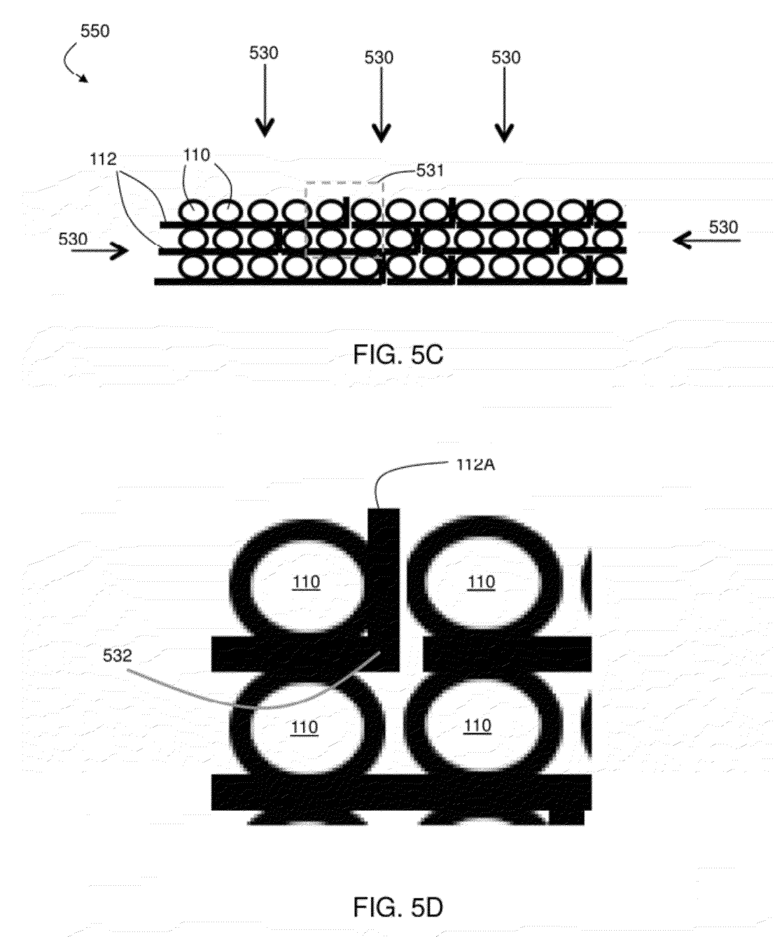

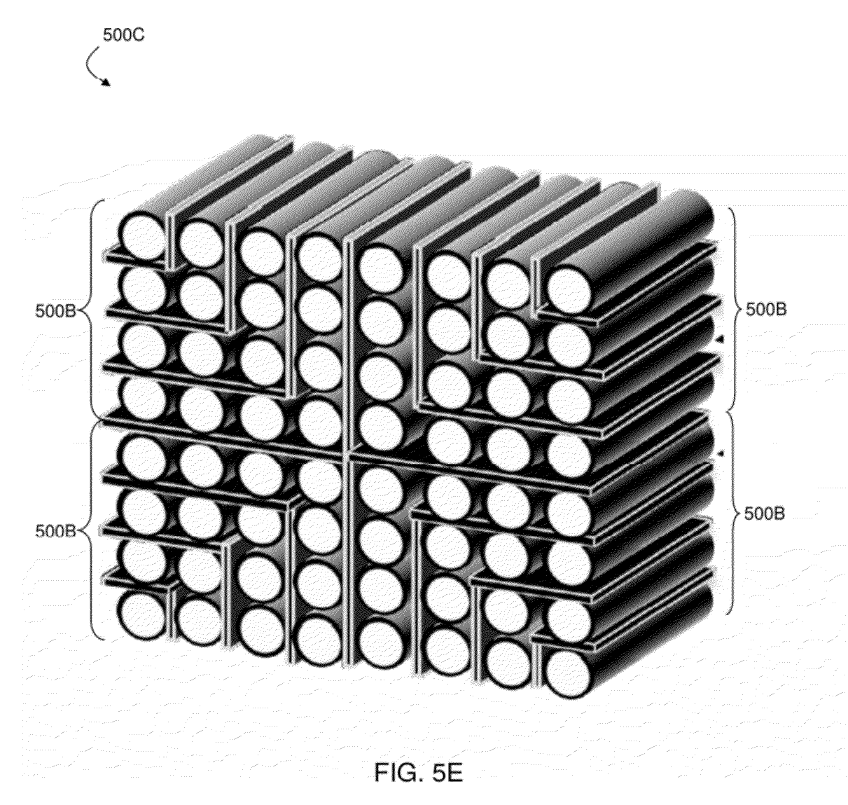

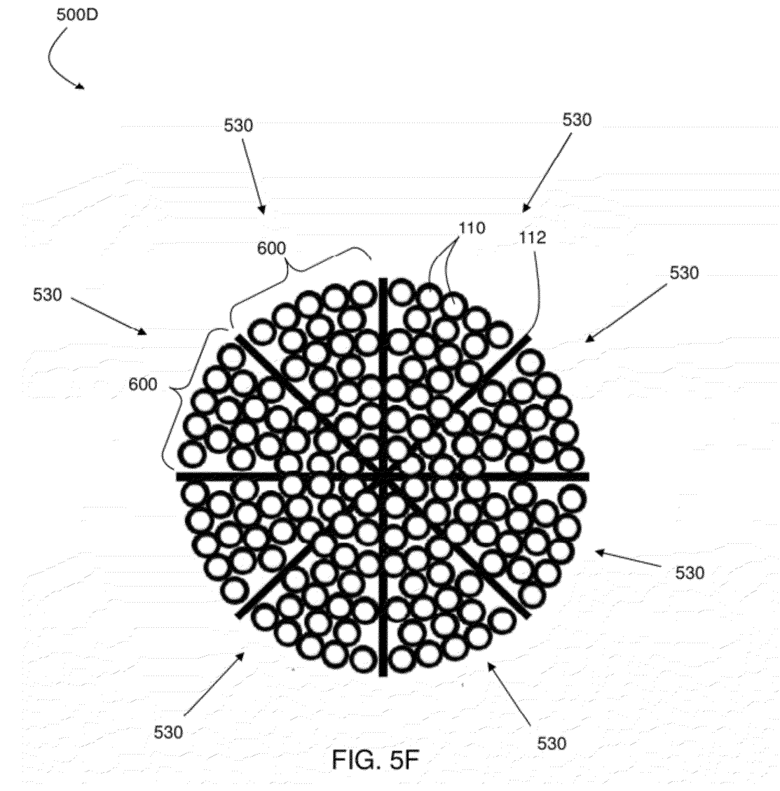

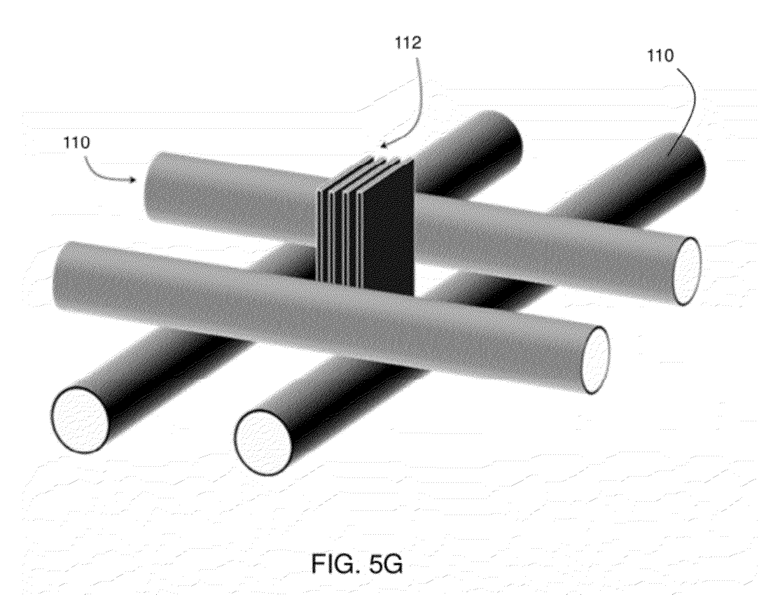

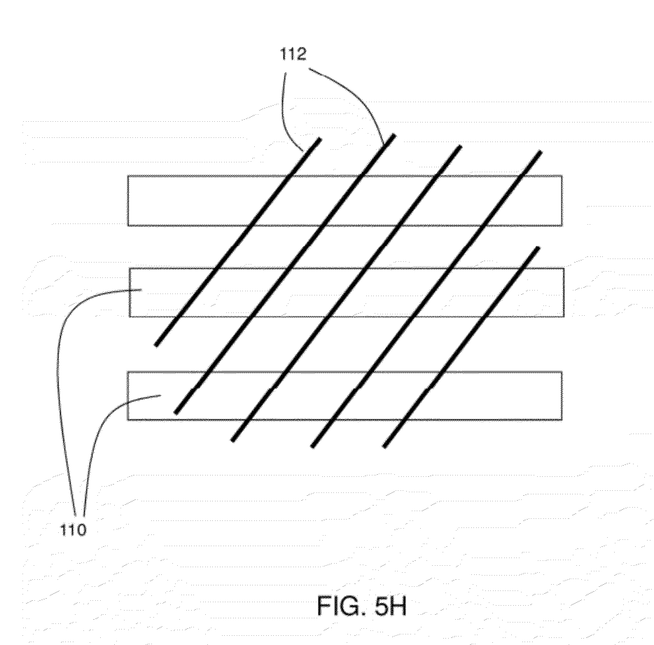

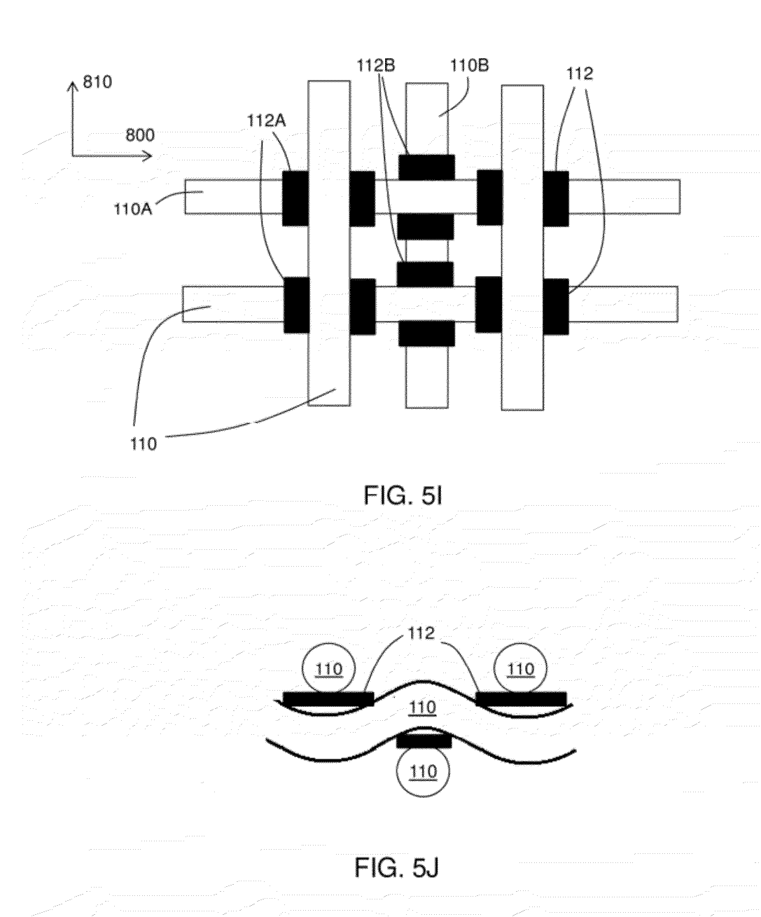

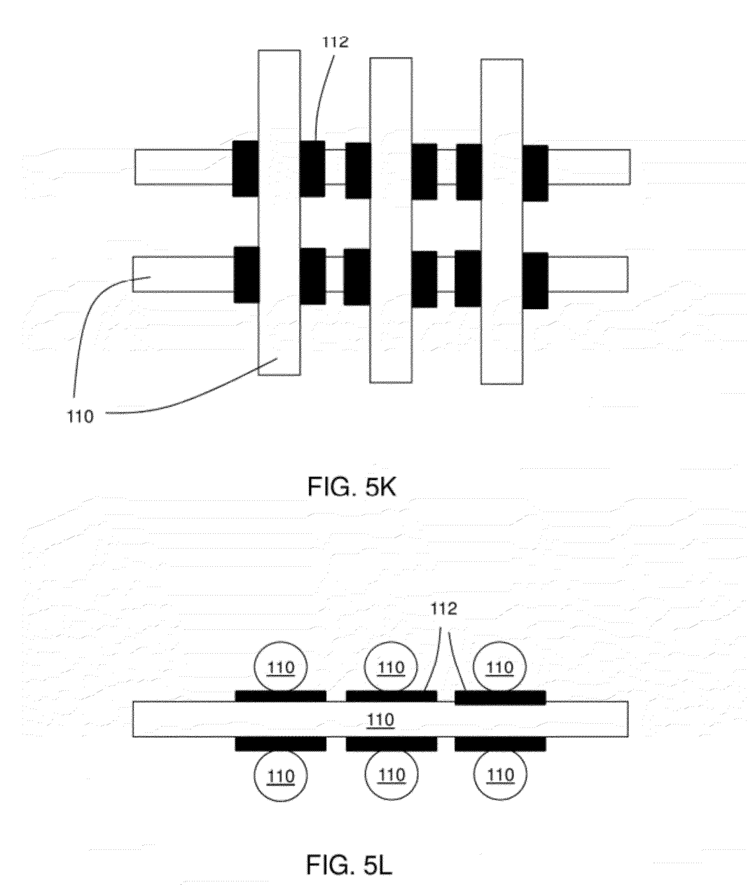

In some embodiments, the longitudinal axis of a fiber and/or of elongated nanostructures may be a substantially straight line. For example, longitudinal axes 120 of elongated nanostructures 112 in FIG. 1 are substantially straight lines. It should be understood, however, that in some embodiments, the longitudinal axis of a fiber and/or of an elongated nanostructure can be curved or bent. For example, in the set of embodiments illustrated in FIGS. 5B-5D (which are described in detail elsewhere herein), elongated nanostructures 112 include longitudinal axes that are bent in an L-shape.

In some embodiments, the elongated nanostructures can be substantially longer than the spaces between adjacent fibers within the article or structure. Accordingly, the lengths of the elongated nanostructures can span multiple fibers within the structure. A length of an elongated nanostructure is said to span a fiber when the length of the nanostructure crosses a first plane tangent to a first side of the fiber and a second plane, parallel to the first plane, tangent to a second side of the fiber opposite the first side. In some embodiments, at least about 50%, at least about 60%, at least about 70%, at least about 80%, at least about 90%, at least about 95%, at least about 99%, or substantially all of the elongated nanostructures within a structure (e.g., a composite structure) span at least about 2, at least about 5, at least about 10, at least about 50, at least about 100, at least about 1000, at least about 10,000, at least about 100,000 or at least about 1,000,000 fibers within the structure. For example, in the set of embodiments illustrated in FIG. 1, the longitudinal axes 120 of each of elongated nanostructures 112 span three fibers 110.

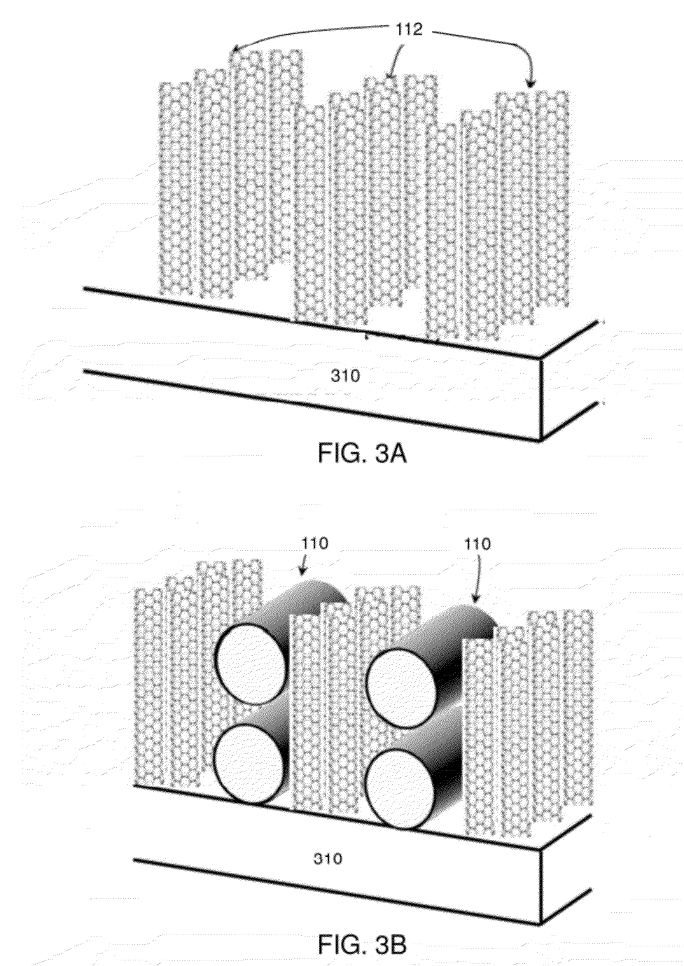

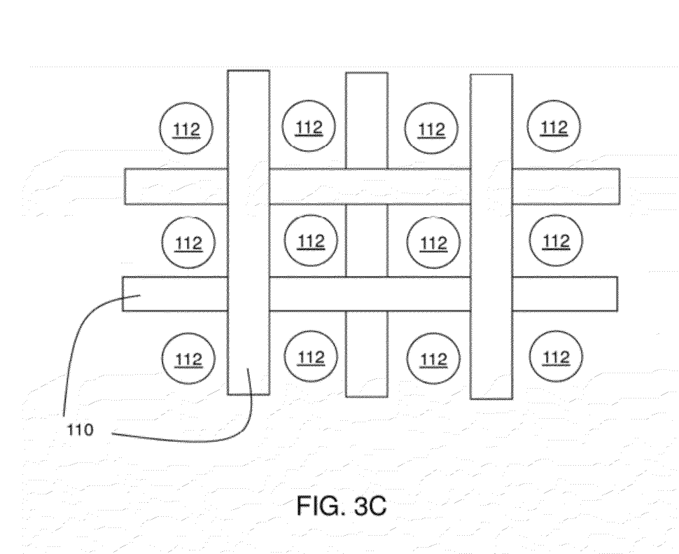

FIGS. 3A-3B include schematic illustrations outlining an exemplary process of assembling elongated nanostructures and fibers. In this set of embodiments, elongated nanostructures (e.g., carbon nanotubes) are grown on growth substrate 310 and arranged in rows. The nanostructures can be arranged in rows by, for example, depositing a growth catalyst on the growth substrate and patterning the catalyst (e.g., using photolithography, screen printing, or any other suitable method) such that it forms rows on the growth substrate. Upon growing the nanostructures using the catalyst (e.g., via chemical vapor deposition), rows of nanostructures corresponding to the rows of catalyst can be formed. Of course, elongated nanostructures can be grown in rows using other suitable methods. For example, in some embodiments, the elongated nanostructures can be grown as a substantially evenly distributed forest, and the nanostructures can be re-positioned in rows by applying a first external force to the sides of the nanostructures, which can compress adjacent nanostructures closer together, resulting in the formation of rows. In some embodiments, a second external force (orthogonal to the first external force) can be applied to the nanostructures to form bundles of nanostructures. Systems and methods for growing nanostructures (e.g., aligned nanostructures) are described, for example, in International Patent Application Serial No. PCT/US2007/011914, filed May 18, 2007, entitled “Continuous Process for the Production of Nanostructures Including Nanotubes,” published as WO 2007/136755 on Nov. 29, 2007; U.S. patent application Ser. No. 12/227,516, filed Nov. 19, 2008, entitled “Continuous Process for the Production of Nanostructures Including Nanotubes,” published as US 2009/0311166 on Dec. 17, 2009; International Patent Application Serial No. PCT/US07/11913, filed May 18, 2007, entitled “Nanostructure-reinforced Composite Articles and Methods,” published as WO 2008/054541 on May 8, 2008; International Patent Application Serial No. PCT/US2008/009996, filed Aug. 22, 2008, entitled “Nanostructure-reinforced Composite Articles and Methods,” published as WO 2009/029218 on Mar. 5, 2009; U.S. patent application Ser. No. 11/895,621, filed Aug. 24, 2007, entitled “Nanostructure-Reinforced Composite Articles and Methods,” published as US 2008/0075954 on Mar. 27, 2008, each of which is incorporated herein by reference in its entirety for all purposes.

Referring back to FIGS. 3A-3B, once the nanostructures have been arranged in rows, fibers can be inserted between the nanostructures. Fibers can be inserted between the nanostructures using any suitable process, for example, by manual insertion or by using an automated system. In FIG. 3B, fibers 110 have been arranged such that their longitudinal axes extend within the trenches between nanostructures 112. As mentioned elsewhere, fibers 110 can be of any suitable form factor (e.g., a fiber fabric, a fiber tow, a unidirectional cloth, etc.). In some embodiments, after the fibers have been assembled between the nano structures, the nanostructure/fiber architecture can be released from the growth substrate. Before or after the nanostructure/fiber architecture is released, a binding material (e.g., comprising a polymer such as an epoxy) can be dispersed between the nanostructures and the fibers using any suitable procedure (e.g., capillarity wetting, resin infusion transfer molding (RTM), hand lay-up, oxidative-CVD (o-CVD), initiated-CVD (i-CVD), etc.). In some embodiments, after the fibers and nanostructures have been assembled, an external force can be applied to the assembly to spatially densify the nanostructures and the fibers. In some instances, an external force can be applied to the assembly to spatially densify the nanostructures and the fibers before and/or after a binding material is added to the assembly to form a composite.

While the embodiments illustrated in FIGS. 3A-3B illustrate articles in which the nanostructures are arranged in rows, it should be understood that other arrangements are also possible. For example, in some embodiments, the nanostructures can be arranged in rows and columns of nanostructure bundles, and the fibers can be arranged within the spaces between the rows and/or columns of nanostructure bundles. FIG. 3C includes an exemplary top-view schematic illustration of one such set of embodiments. In FIG. 3C, nanostructures 112 have been arranged in a 3×4 matrix, and fibers 110 have been arranged such that they lie within the spaces formed between the nanostructures.

While assembly of nanostructures grown on a growth substrate has been illustrated in FIGS. 3A-3B, it should be understood that, in other embodiments, the nanostructures can be removed from the growth substrate after they are formed but prior to being assembled with the fibers or the nanostructures. For example, in certain embodiments, nanostructures (e.g., rows, sheets, yarns, tows, etc.) can be removed from substrate 310 and subsequently assembled with fibers 110 (to assume any form factor described herein) in the absence of a substrate. The act of removing the nanostructures can comprise transferring the nanostructures directly from the surface of a growth catalyst or growth substrate to a surface of a receiving substrate. In some embodiments, the act of removing the nanostructures can comprise application of a force with a mechanical tool, mechanical or ultrasonic vibration, a chemical reagent, heat, or other sources of external energy, to the nanostructures, the growth catalyst, and/or the surface of the growth substrate. In some cases, the nanostructures may be removed by application of compressed gas, for example. In some cases, the nanostructures may be removed (e.g., detached) and collected in bulk, without attaching the nanostructures to a receiving substrate, and the nanostructures may remain in their original or “as-grown” orientation and conformation (e.g., in an aligned “forest”) following removal from the growth substrate. Systems and methods for removing nanostructures from a substrate, or for transferring nanostructures from a first substrate to a second substrate, are described in International Patent Application Serial No. PCT/US2007/011914, filed May 18, 2007, entitled “Continuous Process for the Production of Nanostructures Including Nanotubes,” and U.S. patent application Ser. No. 12/618,203, filed on Nov. 13, 2009, entitled “Controlled-Orientation Films and Nanocomposites Including Nanotubes or Other Nanostructures,” published as U.S. Patent Publication No. 2010/0196695, on Aug. 5, 2010, each of which is incorporated herein by reference in its entirety for all purposes.

In some embodiments, the nanostructures can be produced without the use of a growth substrate and assembled with the fibers (e.g., as individuated nanostructures, bundles of nanostructures, strips of nanostructures, or in other forms) in the absence of a substrate.

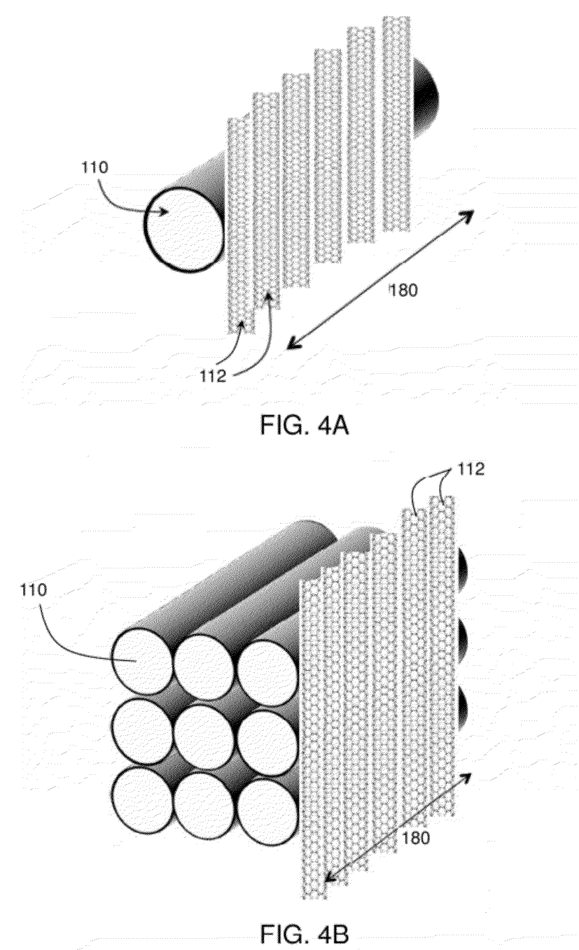

FIG. 1 illustrates a set of embodiments in which a strip of elongated nanostructures (or a strip of bundles of elongated nanostructures) are arranged adjacent a strip of fibers (or a strip of bundles of fibers). However, other arrangements are also possible. For example, in some embodiments, interlaminar, intralaminar, inter-tow, inter-fiber, and inter-fibergroup architectures can be produced using the methods described herein. In the set of embodiments illustrated in FIG. 4A, a single fiber (or a single bundle of fibers) are arranged adjacent a row of elongated nanostructures (or a row of nanostructure bundles). In the set of embodiments illustrated in FIG. 4B, the fibers are arranged in a 3×3 matrix and positioned adjacent a row of elongated nanostructures. In some embodiments in which the elongated nanostructures are used for interlaminar reinforcement, the elongated nanostructures can cross the interlaminar interface surface. In some instances, the fibers and/or the strip of elongated nanostructures can extend a very long length in the direction of dimension 180 in FIGS. 4A-4B (e.g., at least about 100 times, at least about 1000 times, at least about 10,000 times, at least about 10⁶ times, or at least about 10⁹ times the average of the smallest cross-sectional dimensions of the fibers), as fibers and strips of elongated nanostructures can be grown/produced continuously.

FIG. 5A includes a schematic illustration of another exemplary arrangement of elongated nanostructures and fibers. In FIG. 5A, rows of fibers 110 and elongated nanostructures 112 are stacked on each other. The longitudinal axes of the elongated nanostructures 112 can extend along vector 510 in some embodiments, while in other embodiments, the longitudinal axes of nanostructures 112 can extend along vector 512 (or along any other suitable direction).

In some embodiments, the assembly of nanostructures and fibers can be folded, bent, twisted, or otherwise mechanically manipulated. For example, in the set of embodiments illustrated in FIG. 5B, assembly 500 in FIG. 5A has been folded in the direction of arrows 520 to form assembly 500B including a right angle at point 522. Bending, folding, twisting, or otherwise mechanically manipulating assemblies of nanostructures and/or fibers can be performed by using a mold, in some embodiments. For example, in the set of embodiments illustrated in FIG. 5B, the assembly 500 is folded to form assembly 500B, which conforms to the right angle formed within mold 560. While a right angle is illustrated in FIG. 5B, it should be understood that the nanostructures and/or fibers can be folded to produce any suitable angle. In some embodiments, the assembly of nanostructures and fibers can be densified, for example, by applying an external force in the direction of arrows 530.

In some embodiments, fibers and/or nanostructures within the assembly can be folded, bent, twisted, or otherwise mechanically manipulated. For example, in the set of embodiments illustrated in FIG. 5C, nanostructures 112 within assembly 550 have been bent such that they form right angles between fibers 110. FIG. 5D includes a close-up view of region 531 in FIG. 5C, illustrating the angle formed by nanostructures 112A between fibers 110 within region 532. In some embodiments, the assembly of nanostructures and fibers can be densified, for example, by applying an external force in the direction of arrows 530.

In certain embodiments, bundles of elongated nanostructures (e.g., strips, toes, yarns, or other bundles of elongated nanostructures) can be used to substantially fill small spaces within a composite structure. In this way, the elongated nanostructures can be used to occupy void spaces within a composite, similar to filler structures known as “noodles” in composites manufacturing. Bundles of elongated nanostructures can be used in place of or in addition to traditional noodle structures. Positioning the elongated nanostructures in this way can reinforce the structure within small spaces. For example, in the set of embodiments illustrated in FIG. 5B, a strip of elongated nanostructures has been used to fill the space adjacent the right angle at point 522. In other embodiments, bundles of elongated nanostructures can be used to fill rounded corners or corners defining relatively small angles (e.g., angles of 60° or less, angles of 45° or less, angles of 30° or less, or angles of 15° or less).

Multiple assemblies of elongated nanostructures and fibers can be joined to form larger assemblies of elongated nanostructures and fibers, in some embodiments. For example, in the set of embodiments illustrated in FIG. 5E, assembly 500C is formed by joining a plurality of assemblies 500B.

FIG. 5F includes a schematic cross-sectional illustration of another type of assembly that can be formed using the methods described herein. In the set of embodiments illustrated in FIG. 5F, assemblies 600 can be formed by folding elongated nanostructures to form acute angles (e.g., angles of about 45° in the set of embodiments illustrated in FIG. 5F), and a larger assembly 500D can be formed by joining a plurality of assemblies 600. In some embodiments, the assembly of nanostructures and fibers can be densified, for example, by applying an external force in the direction of arrows 530.

FIG. 5G includes a schematic illustration of yet another set of embodiments. In this set of embodiments, elongated nanostructures 112 are arranged between fibers 110, which can be in the form of, for example, a stack or a weave. As mentioned elsewhere, while strips of elongated nanostructures are illustrated in FIG. 5G, it should be understood that individuated nanostructures, one or more bundles of nanostructures, or other configurations of nanostructures can be used in addition to or in place of the strips of nanostructures illustrated in FIG. 5G. Structures such as those illustrated in FIG. 5G can be useful, for example, in thin laminates in, for example, small satellites (e.g., cubeSat).

In certain embodiments, fibers and elongated nanostructures can be arranged such that the elongated nanostructures reinforce areas in which the fibers would otherwise come into contact. In some embodiments, a cohesive structure comprises a first fiber and a second fiber, and an elongated nanostructure and/or a bundle of elongated nanostructures positioned between the fibers such that the elongated nanostructure and/or bundle of elongated nano structures are in contact with the first and second fibers. For example, in FIG. 3B, the middle strip of elongated nanostructures is in direct contact with fibers on either side of the middle strip. Similarly, in FIGS. 5A-5G, many of the bundles of elongated nanostructures are positioned such that they are between and in contact with two or more fibers.

In certain embodiments, the elongated nanostructure (or bundle of elongated nanostructures) can be positioned such that the elongated nanostructure(s) is between two (or more) fibers and in direct contact with the two (or more) fibers. An example of such an arrangement is illustrated in FIG. 3B. In other embodiments, the elongated nanostructure (or bundle of elongated nanostructures) can be positioned such that the elongated nanostructure(s) is between two (or more) fibers and in indirect contact with the two (or more) fibers. Generally, two objects are in indirect contact when at least one path can be traced between the two objects while remaining within a solid material, even though the two objects are not directly touching. For example, a fiber and an elongated nanostructure bonded by an adhesive positioned between the fiber and the elongated nanostructure would be in indirect contact because a path can be traced from the fiber to the elongated nanostructure while remaining in a solid material (i.e., the adhesive).

In certain embodiments, two elongated objects in indirect contact with each other are be positioned such that the shortest distance between the two elongated objects is less than about 5 times, less than about 2 times, or less than about 1 time the maximum cross-sectional dimension of the smaller of the two elongated objects. For example, a fiber and an elongated nanostructure can be in indirect contact, in certain cases, when the shortest distance between the fiber and the elongated nanostructure is less than about 5 times, less than about 2 times, or less than about 1 time the maximum cross-sectional dimension of the elongated nanostructure.

In some embodiments, elongated nanostructures (or bundles of elongated nanostructures) can be positioned between fibers (or bundles of fibers) at one or more positions where the fibers overlap, as might be observed in a stack or weave of fibers (or a stack or weave of bundles of fibers). Positioning elongated nanostructures in this way can inhibit the degree to which fibers (or bundles of fibers) come into direct contact with each other, thereby limiting (and in certain cases, eliminating) mechanical degradation. Generally, elongated structures (e.g., fibers) are said to overlap when their longitudinal axes form an angle of at least about 15° with each other and their longitudinal axes intersect when viewed from at least one angle. In certain embodiments, the shortest distance between two overlapping elongated structures is less than about 5 times, less than about 2 times, or less than about 1 time the maximum cross sectional dimension of the smaller of the two overlapping structures. The region in which two elongated structures overlap generally refers to the region in which the longitudinal axes intersect.

FIGS. 5I-5J illustrate one set of embodiments in which nanostructure bundles 112 are positioned between fibers 110 such that the nanostructure bundles are in contact with the fibers within regions of overlap. FIG. 5I is a top-view schematic illustration, while FIG. 5J is a side view schematic illustration. In FIG. 5I-5J, fibers 110 are arranged in a weave. In other embodiments, the fibers can be arranged in a stacked configuration, as shown, for example, in FIG. 5K (top-view) and FIG. 5L (side-view of FIG. 5K).

In certain embodiments, the elongated nanostructure(s) can be positioned between two fibers (or bundles of fibers) whose longitudinal axes are arranged at an angle relative to each other. For example, in certain cases, the longitudinal axes of the fibers can be substantially orthogonal to each other, as illustrated in FIGS. 5I-5L. In some embodiments, the elongated nanostructure(s) are positioned between two fibers (e.g., within a region of overlap) whose longitudinal axes form an angle of at least about 15°, at least about 30°, at least about 45°, at least about 60°, or at least about 75°.

In certain embodiments, the elongated nanostructures (or bundles of elongated nanostructures) can be arranged such that the longitudinal axes of the nanostructures are substantially aligned with at least one adjacent fiber. For example, in FIG. 5I, the longitudinal axes of the elongated nanostructures within bundle 112A can be substantially aligned in the direction of arrow 800, which is substantially parallel to the longitudinal axis of fiber 110A. In certain embodiments, the longitudinal axes of the elongated nanostructures within bundle 112B are substantially aligned in the direction of arrow 810, which is substantially parallel to the longitudinal axis of fiber 110B.

As mentioned elsewhere herein, external forces can be applied to the nanostructures and/or fibers, before and/or after assembly, to increase the density of the nanostructures and/or fibers within the assembly. Application of a force to the nanostructures, fibers, and/or assemblies of nanostructures and fibers can produce articles with relatively high volume fractions of fibers (V_{f}) and/or relatively high volume fractions of nanostructures (V_{NS}). Not wishing to be bound by any particular theory, compaction of organizations of nanostructures such as carbon nanotubes (e.g., aligned carbon nanotubes such as those observed in vertical arrays) can be relatively easy, in some embodiments, because the modulus in the direction orthogonal to the longitudinal axes of the nanostructures can be relatively low (e.g., about 1 MPa), whereas the stiffness in the axial direction (along the longitudinal axis) can be hundreds of MPa. The application of external forces to a plurality of nanostructures is described, for example, in U.S. patent application Ser. No. 12/618,203, filed Nov. 13, 2009, entitled “Controlled-Orientation Films and Nanocomposites Including Nanotubes or Other Nanostructures,” published as U.S. Patent Application Publication No. 2010/0196695 on Aug. 5, 2010, which is incorporated herein by reference in its entirety for all purposes.

The elongated nanostructures and/or fibers can be arranged, in some embodiments, such that a relatively high volume fraction of the article or structure is occupied by the fibers and/or elongated nanostructures (i.e., there can be little open space between adjacent fibers and elongated nanostructures). In some embodiments, the percentage of the volume of the article or structure occupied by fibers and/or elongated nanostructures can be at least about 20%, at least about 30%, at least about 40%, at least about 50%, or at least about 60%.

The systems and methods described herein may be used to produce substantially aligned nanostructures or may involve the use of substantially aligned nanostructures, in some embodiments. The substantially aligned nanostructures can have sufficient length and/or diameter to enhance the properties of a material when arranged on or within the material. In some embodiments, the set of substantially aligned nanostructures may be formed on a surface of a growth substrate, and the nanostructures may be oriented such that the longitudinal axes of the nanostructures are substantially non-planar with respect to the surface of the growth substrate. In some cases, the longitudinal axes of the nanostructures are oriented in a substantially perpendicular direction with respect to the surface of the growth substrate, forming a nanostructure array or “forest.” The alignment of nanostructures in the nanostructure “forest” may be substantially maintained, even upon subsequent processing (e.g., transfer to other surfaces, between and/or along fibers, and/or combining the forests with secondary materials such as polymers), in some embodiments. Systems and methods for producing aligned nanostructures and articles comprising aligned nanostructures are described, for example, in International Patent Application Serial No. PCT/US2007/011914, filed May 18, 2007, entitled “Continuous Process for the Production of Nanostructures Including Nanotubes”; and U.S. Pat. No. 7,537,825, issued on May 26, 2009, entitled “Nano-Engineered Material Architectures: Ultra-Tough Hybrid Nanocomposite System,” which are incorporated herein by reference in their entirety. In some embodiments, it can be advantageous to incorporate substantially aligned nanostructures and/or fibers, as aligned nanostructures and/or fibers can enhance the degree to which binding materials can be interspersed between the nanostructures and/or fibers (e.g., via capillary wetting). In addition, in some embodiments, substantially aligned nanostructure and/or fibers can be relatively easy to compress, relative to those that are not aligned, as described elsewhere.

In some embodiments, at least about 50%, at least about 60%, at least about 70%, at least about 80%, at least about 90%, at least about 95%, at least about 99%, or substantially all of the longitudinal axes of the elongated nanostructures are positioned relative to at least about 50%, at least about 60%, at least about 70%, at least about 80%, at least about 90%, at least about 95%, at least about 99%, or substantially all of the longitudinal axes of the fibers such that the smallest angle defined by the longitudinal axes of the aligned elongated nanostructures and the longitudinal axes of the adjacent aligned fibers is between about 45° and about 90°, between about 60° and about 90°, between about 75° and about 90°, between about 85° and about 90°, or between about 88° and about 90°. For example, in the set of embodiments illustrated in FIG. 1, the nanostructures and fibers are arranged such the smallest angles formed between substantially all of the of the longitudinal axes of the nanostructures and substantially all of the fibers are about 90°. In the set of embodiments illustrated in FIG. 5H the nanostructures and fibers are arranged such the smallest angles formed between substantially all of the of the longitudinal axes of the nanostructures and substantially all of the longitudinal axes of the fibers are about 45°.

As mentioned elsewhere herein, composite articles can be formed by including a binding material between the fibers, between the nanostructures, and/or between the fibers and the nanostructures in some embodiments. The binding material (or a precursor to a binding material) can be formed between the nanostructures and/or fibers using any suitable method. For example, in some embodiments, the binding material (or a precursor to the binding material) can be deposited via capillary wetting, resin infusion transfer molding (RTM), hand lay-up, oxidative chemical vapor deposition (o-CVD), initiated chemical vapor deposition (i-CVD), and the like.

A variety of types of binding materials can be used in association with the embodiments described herein. In some cases, the binding material (e.g., a polymer binding material) can be selected to uniformly “wet” the nanostructures and/or fibers, and/or selected to bind one or more laminates. In some cases, the binding material may be selected to have a particular viscosity, such as 50,000 cPs or lower, 10,000 cPs or lower, 5,000 cPs or lower, 1,000 cPs or lower, 500 cPs or lower, 250 cPs or lower, or, 100 cPs or lower. In some embodiments, the binding material may be selected to have a viscosity between 150-250 cPs.

In some cases, the binding material may comprise a monomer, a polymer, a ceramic, a metal, and/or a silane. The binding material can be further processed, in some embodiments, to support the nanostructures and/or fibers.

In some cases, the polymer material may comprise a thermoset or thermoplastic. For example, in some embodiments, the binding material can comprise thermoset materials such as epoxy, rubber strengthened epoxy, BMI, PMK-15, polyesters, vinylesters, and the like, and/or thermoplastic materials such as polyamides, polyimides, polyarylene sulfide, polyetherimide, polyesterimides polyarylenes polysulfones polyethersulfones polyphenylene sulfide, polyetherimide, polypropylene, polyolefins, polyketones, polyetherketones, polyetherketoneketone, polyetheretherketones, polyester, and analogs and mixtures thereof. In some embodiments, the binding material can comprise a polyurethane and/or a polyvinyl alcohol.

Specific examples of thermosets include Microchem SU-8 (UV curing epoxy, grades from 2000.1 to 2100, and viscosities ranging from 3 cPs to 10,000 cPs), Buehler Epothin (low viscosity, ˜150 cPs, room temperature curing epoxy), West Systems 206+109 Hardener (low viscosity, ˜200 cPs, room temperature curing epoxy), Loctite Hysol 1C (20-min curing conductive epoxy, viscosity 200,000-500,000 cPs), Hexcel RTM6 (resin transfer molding epoxy, viscosity during process ˜10 cPs), Hexcel HexFlow VRM 34 (structural VARTM or vacuum assisted resin transfer molding epoxy, viscosity during process ˜500 cPs). Examples of thermoplastic include polystyrene, or Microchem PMMA (UV curing thermoplastic, grades ranging from 10 cPs to ˜1,000 cPs). In one embodiment, the polymer material may be PMMA, EpoThin, WestSystems EPON, RTM6, VRM34, 977-3, SU8, or Hysol1C.

The addition of binding materials to assemblies of elongated nanostructures (e.g., aligned nanostructures) is described, for example, in International Patent Application Serial No. PCT/US2007/011914, filed May 18, 2007, entitled “Continuous Process for the Production of Nanostructures Including Nanotubes,” published as WO 2007/136755 on Nov. 29, 2007; U.S. patent application Ser. No. 12/227,516, filed Nov. 19, 2008, entitled “Continuous Process for the Production of Nanostructures Including Nanotubes,” published as US 2009/0311166 on Dec. 17, 2009; International Patent Application Serial No. PCT/US07/11913, filed May 18, 2007, entitled “Nanostructure-reinforced Composite Articles and Methods,” published as WO 2008/054541 on May 8, 2008; International Patent Application Serial No. PCT/US2008/009996, filed Aug. 22, 2008, entitled “Nanostructure-reinforced Composite Articles and Methods,” published as WO 2009/029218 on Mar. 5, 2009; U.S. patent application Ser. No. 11/895,621, filed Aug. 24, 2007, entitled “Nanostructure-Reinforced Composite Articles and Methods,” published as US 2008/0075954 on Mar. 27, 2008; and U.S. patent application Ser. No. 12/618,203, filed Nov. 13, 2009, entitled “Controlled-Orientation Films and Nanocomposites Including Nanotubes or Other Nanostructures,” published as U.S. Patent Application Publication No. 2010/0196695 on Aug. 5, 2010, each of which is incorporated herein by reference in its entirety for all purposes. The use of chemical vapor deposition to add binding materials to assemblies of elongated nanostructures is described, for example, in U.S. patent application Ser. No. 12/630,289, filed Dec. 3, 2009, entitled “Multifunctional Composites Based on Coated Nanostructures,” published as U.S. Patent Application Publication No. 2010/0255303 on Oct. 7, 2010, which is incorporated herein by reference in its entirety for all purposes.

A variety of types of fibers can be used in association with the articles, systems, and methods described herein. In some embodiments, the fibers can comprise carbon (e.g., in the case of carbon fibers), a polymer (e.g., extruded polymeric filaments), Al₂O₃, a silicon oxide (e.g., glass fibers such as those comprising SiO₂), a cellulosic material (e.g., cotton, rayon, and the like), basalt (e.g., basalt fibers) and/or a metal. The fibers can be arranged in any suitable manner. For example, in some cases, multiple fibers can be arranged in one or more tows. In some embodiments, the fibers and/or bundles of fibers can be woven, knitted, or otherwise assembled to form a fabric.

In some embodiments, the elongated nanostructures can comprise elongated carbon-based nanostructures. As used herein, the term “elongated carbon-based nanostructure” refers to elongated nanostructures having a fused network of aromatic rings and comprising at least about 30% carbon by mass. In some embodiments, the elongated carbon-based nanostructures may comprise at least about 40%, at least about 50%, at least about 60%, at least about 70%, at least about 80%, at least about 90%, or at least about 95% of carbon by mass, or more. The term “fused network” might not include, for example, a biphenyl group, wherein two phenyl rings are joined by a single bond and are not fused. Example of elongated carbon-based nanostructures include carbon nanotubes (e.g., single-walled carbon nanotubes, double-walled carbon nanotubes, multi-walled carbon nanotubes, etc.), carbon nanowires, carbon nanofibers, and the like.

In some embodiments, the elongated carbon-based nanostructures described herein may comprise carbon nanotubes. As used herein, the term “carbon nanotube” is given its ordinary meaning in the art and refers to a substantially cylindrical molecule or nanostructure comprising a fused network of primarily six-membered rings (e.g., six-membered aromatic rings) comprising primarily carbon atoms. In some cases, carbon nanotubes may resemble a sheet of graphite formed into a seamless cylindrical structure. It should be understood that the carbon nanotube may also comprise rings or lattice structures other than six-membered rings. The ends of the carbon nanotubes can be capped (i.e., with a curved or nonplanar aromatic structure) or uncapped. In some embodiments, carbon nanotubes can have maximum cross-sectional diameters on the order of nanometers and a length on the order of millimeters, or, on the order of tenths of micrometers, resulting in an aspect ratio greater than 100, 1000, 10,000, 100,000, 10⁶, 10⁷, 10⁸, 10⁹, or greater. Examples of carbon nanotubes include single-walled carbon nanotubes (SWNTs), double-walled carbon nanotubes (DWNTs), multi-walled carbon nanotubes (MWNTs) (e.g., concentric carbon nanotubes), inorganic derivatives thereof, and the like. In some embodiments, the carbon nanotube is a single-walled carbon nanotube. In some cases, the carbon nanotube is a multi-walled carbon nanotube (e.g., a double-walled carbon nanotube). In some cases, the carbon nanotube may have a maximum cross-sectional diameter of less than about 100 nm, less than about 50 nm, less than about 25 nm, less than about 10 nm, or, in some cases, less than about 1 nm.

The following patents and patent applications are incorporated herein by reference in their entireties for all purposes: International Patent Application Serial No. PCT/US2007/011914, filed May 18, 2007, entitled “Continuous Process for the Production of Nanostructures Including Nanotubes,” published as WO 2007/136755 on Nov. 29, 2007; U.S. patent application Ser. No. 12/227,516, filed Nov. 19, 2008, entitled “Continuous Process for the Production of Nanostructures Including Nanotubes,” published as US 2009/0311166 on Dec. 17, 2009; International Patent Application Serial No. PCT/US07/11913, filed May 18, 2007, entitled “Nanostructure-reinforced Composite Articles and Methods,” published as WO 2008/054541 on May 8, 2008; International Patent Application Serial No. PCT/US2008/009996, filed Aug. 22, 2008, entitled “Nanostructure-reinforced Composite Articles and Methods,” published as WO 2009/029218 on Mar. 5, 2009; U.S. patent application Ser. No. 11/895,621, filed Aug. 24, 2007, entitled “Nanostructure-Reinforced Composite Articles and Methods,” published as US 2008/0075954 on Mar. 27, 2008; U.S. Pat. No. 7,537,825, issued on May 26, 2009, entitled “Nano-Engineered Material Architectures: Ultra-Tough Hybrid Nanocomposite System”; U.S. patent application Ser. No. 11/895,621, filed Aug. 24, 2007, entitled “Nanostructure-Reinforced Composite Articles,” published as U.S. Patent Application Publication No. 2008/0075954 on Mar. 27, 2008; U.S. Provisional Patent Application 61/114,967, filed Nov. 14, 2008, entitled “Controlled-Orientation Films and Nanocomposites Including Nanotubes or Other Nanostructures”; U.S. patent application Ser. No. 12/618,203, filed Nov. 13, 2009, entitled “Controlled-Orientation Films and Nanocomposites Including Nanotubes or Other Nanostructures,” published as U.S. Patent Application Publication No. 2010/0196695 on Aug. 5, 2010; U.S. patent application Ser. No. 12/630,289, filed Dec. 3, 2009, entitled “Multifunctional Composites Based on Coated Nanostructures,” published as U.S. Patent Application Publication No. 2010/0255303 on Oct. 7, 2010; U.S. patent application Ser. No. 12/847,905, filed Jul. 30, 2010, entitled “Systems and Methods Related to the Formation of Carbon-Based Nanostructures”; U.S. Provisional Patent Application No. 61/264,506, filed Nov. 25, 2009, and entitled “Systems and Methods for Enhancing Growth of Carbon-Based Nanostructures”; and U.S. Provisional Patent Application Ser. No. 61/418,784, filed Dec. 1, 2010, and entitled “Articles and Methods Related to the Formation of Nanostructure Reinforced Structures.” The articles, systems, and methods described herein may be combined with those described in any of the patents and/or patent applications noted above. All patents and patent applications mentioned herein are incorporated herein by reference in their entirety for all purposes.

The following examples are intended to illustrate certain embodiments of the present invention, but do not exemplify the full scope of the invention.

### Example 1

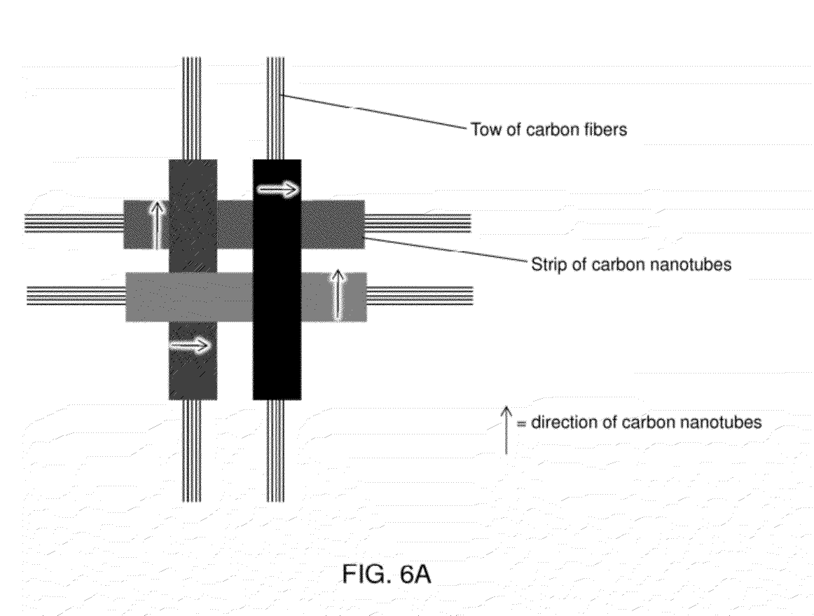

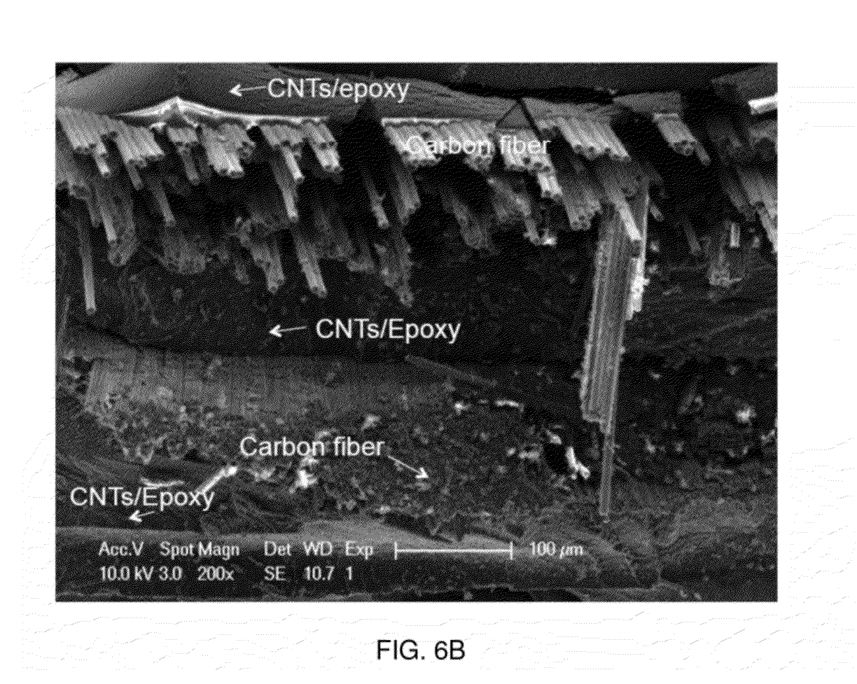

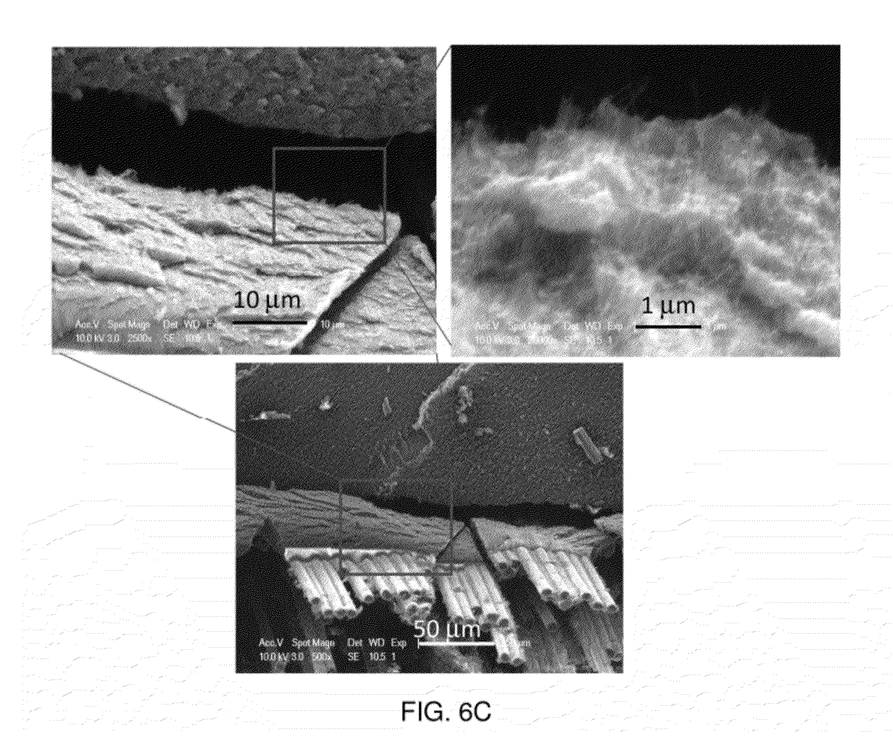

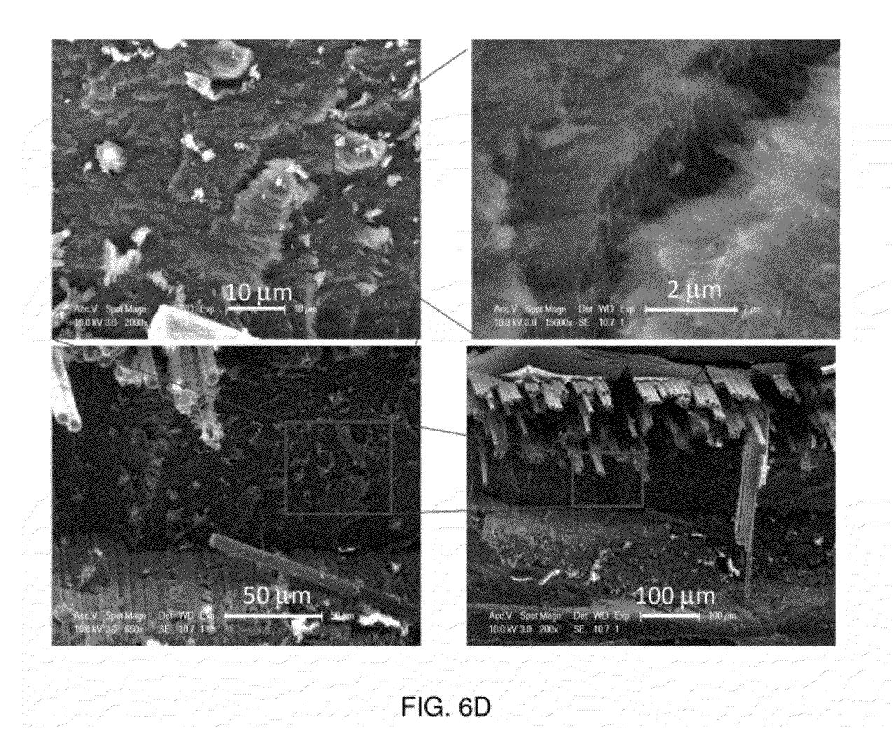

This example describes the fabrication of a composite material comprising carbon nanotubes and carbon fibers. First, a tow of unidirectional carbon fibers (with thicknesses of a few micrometers and lengths of about 100 mm) was slightly wet in an aerospace grade epoxy resin (RTM6). A strip of aligned carbon nanotubes (about 150 micrometers thick, about 1.5 centimeters wide, and about 1 millimeter long) was attached to the slightly wet carbon fiber tow. Four of the carbon fiber tows (with carbon nanotubes attached) were assembled by hand in the orientation shown in FIG. 6A. The carbon nanotube strips appeared only at the center of the specimen because they were 15 mm long whereas the tow length was about 100 mm. The specimen was then infused with RTM6 epoxy resin using a hand-lay up process and cured.

The composite specimen was machined and broken manually. The fracture surface was imaged using scanning electron microscopy (SEM), as shown in FIGS. 6B-6D. The SEM images clearly show carbon fiber/epoxy regions and regions of carbon nanotubes/epoxy (FIG. 6B). The carbon fiber filaments were partially pulled out from the resin during the fracture process, showing a clean surface. The carbon nanotubes remain embedded in the resin rich area, in the middle region of the carbon fiber tows (FIGS. 6C-6D). In the fractured surfaces of the epoxy resin, the carbon nanotubes were partially pulled out from the resin (FIG. 6D).

### Example 2

This example describes the fabrication and testing of a composite article including a prepreg and strips of aligned carbon nanotubes.

In this example, four strips of aligned carbon nanotubes and five prepreg sheets were used. The prepreg material contained aligned, unidirectional carbon fibers. The carbon fibers had diameters of several micrometers and were positioned in an uncured polymeric binding material. The prepreg sheets were cut from a larger prepreg sheet having a thickness of about 150 micrometers. Each of the five cut prepreg sheets had a thickness of about 150 micrometers, a width of about 3 millimeters, and a length of about 300 millimeters. The carbon fibers were substantially aligned in the length direction (i.e., the 300 millimeter dimension).

The carbon nanotube strips were prepared by depositing a catalyst on a wafer in 100 micrometer by 15 millimeter strips, and growing the nanotubes from the catalyst using standard chemical vapor deposition (CVD) techniques. The carbon nanotubes were grown to a height of about 1.5 millimeters. After growth, the aligned carbon nanotubes were removed from the growth substrate to form strips each having a length of about 1.5 millimeters, a width of about 15 millimeters and a thickness of about 100 micrometers. The carbon nanotubes were substantially aligned along the length (i.e., the 1.5 millimeter dimension) of the strips.

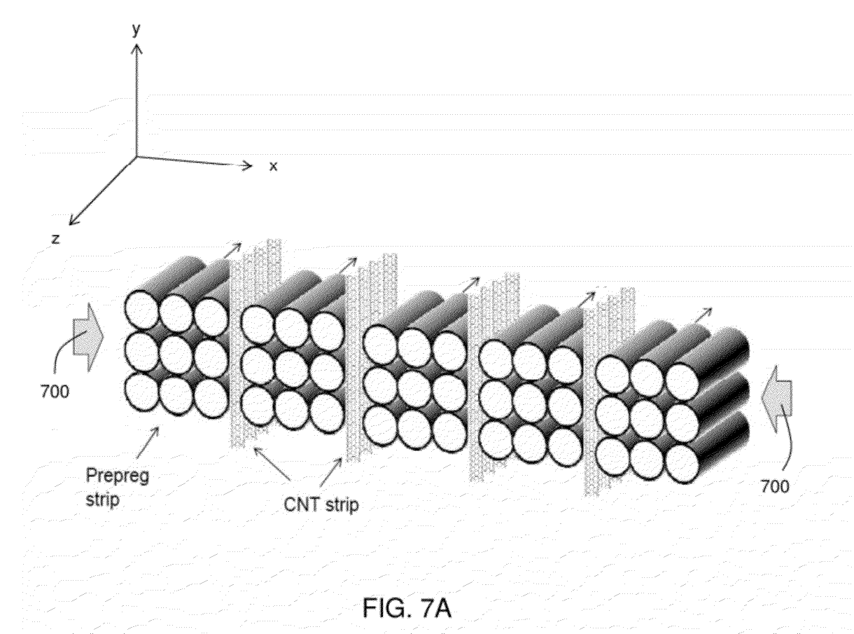

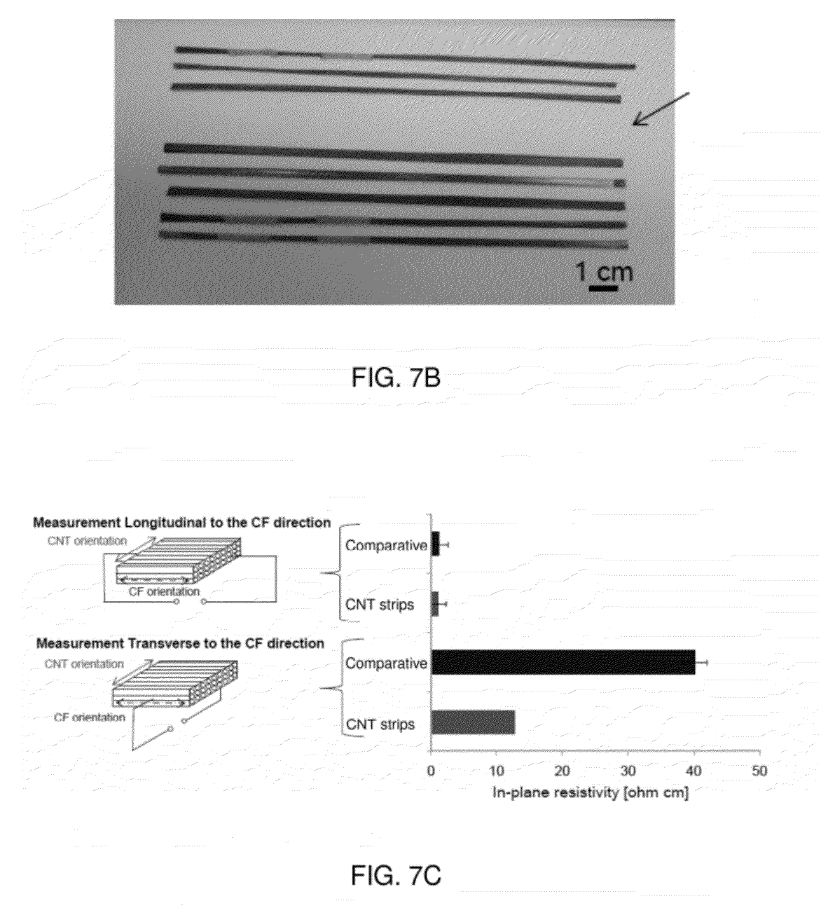

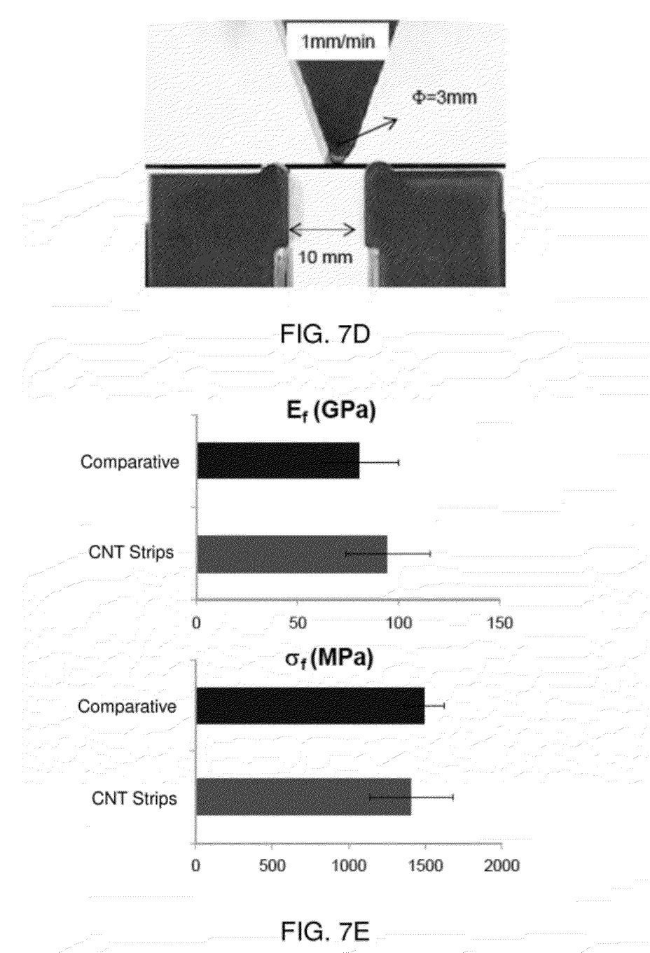

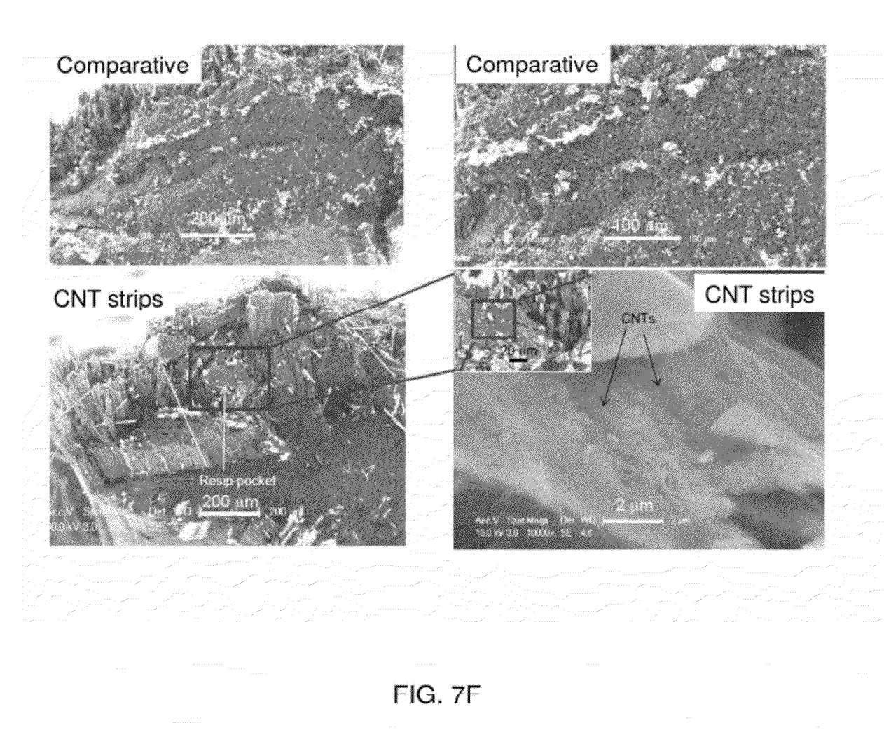

The prepreg sheets and the carbon nanotube strips were assembled by hand in the orientation illustrated in FIG. 7A. For purposes of illustration, FIG. 7A is illustrated as a partial cross-section. In the assembled sample, the prepreg strips extended about 150 micrometers in the x-direction (referring to the coordinate axes illustrated in FIG. 7A), about 3 millimeters in the y-direction, and about 300 millimeters in the z-direction. In the assembled sample, the carbon nanotube strips extended about 100 micrometers in the x-direction, about 1.5 millimeters in the y-direction, and about 15 millimeters in the z-direction. Accordingly, when assembled as illustrated in FIG. 7A, the carbon nanotubes were located near the center of the specimen. After assembling the carbon nanotube strips and prepreg sheets, the assembled part was compressed in the direction of arrows 700.

After assembly, the part was cured in an autoclave and the (uncured) epoxy resin in the prepreg strips flowed into the carbon nanotube strips to form a hierarchical composite “Comparative” samples were fabricated in the same manner, but without including the carbon nanotube strips. Three comparative samples were fabricated, and five samples including carbon nanotube strips were fabricated. The fabricated samples are shown in FIG. 7B.

Each sample was tested for simple DC electrical resistivity in two directions: one direction along the alignment of the carbon fibers and another direction along the alignment of the carbon nanotubes (and substantially orthogonal to the alignment of the carbon fibers). The results of these tests are illustrated in FIG. 7C. The samples including carbon nanotube strips and the comparative samples (without carbon nanotube strips) both exhibited in-plane resistivities of about 1 ohm cm when measured in a direction along the orientation of the carbon fibers. When measured in a direction orthogonal to the orientation of the carbon fibers, the samples including the aligned carbon nanotube strips exhibited in-plane resistivities of about 12 ohm cm. The comparative samples without carbon nanotube strips exhibited much higher in-plane resistivities of about 40 ohm cm. These electrical conductivity results indicated that the presence of the electrically conductive carbon nanotubes enhanced the electrical conductivity of the assembled samples.

In addition, each sample was tested for in-plane mechanical properties. A standard bend test at a load rate of 1 mm/min was performed, which allowed for the extraction of the elastic modulus in the direction of the sample along which the carbon fibers were aligned. The testing apparatus is shown in FIG. 7D, and the test results are summarized in FIG. 7E. The results indicate that the flexural modulus (E_{f}) and strength (σ_{f}) were not substantially affected by the presence of the carbon nanotubes, indicating that the process described in this example did not substantially damage the carbon fibers. This result was significant because other attempts to modify carbon fibers with carbon nanotubes (e.g., fuzzy fibers) have, in some cases, damaged the carbon fibers. The slight increase in flexural strength was within statistical significance, and the overall sample showed that the in-plane properties of the composite were maintained. It is expected that additional tests (e.g., Mode I fracture and open-hole compression testing) will reveal the positive impact of the presence of carbon nanotubes in larger specimens.

Finally, scanning electron microscopy (SEM) images of cross-sections of the samples were obtained, as shown in FIG. 7F. The SEM images revealed the presence of polymeric binding material positioned between the carbon nanotubes in the fractured samples.

### Example 3

This example describes the fabrication and testing of a composite article including dry fibers and strips of aligned carbon nanotubes.

In this example, four strips of aligned carbon nanotubes and five tows of carbon fibers were used. The assembled geometry was similar to that of Example 2, and is illustrated in FIG. 7A. The carbon fiber tows contained aligned, unidirectional carbon fibers, without epoxy or other binding materials. The carbon fibers had diameters of several micrometers. Each of the five carbon fiber tows had a thickness of about 150 micrometers, a width of about 3 millimeters, and a length of about 300 millimeters. The carbon fibers were substantially aligned in the length direction (i.e., the 300 millimeter dimension).

The carbon nanotube strips were prepared by depositing a catalyst on a wafer in 100 micrometer by 15 millimeter strips, and growing the nanotubes from the catalyst using standard chemical vapor deposition (CVD) techniques. The carbon nanotubes were grown to a height of about 1.5 millimeters. After growth, the aligned carbon nanotubes were removed from the growth substrate to form strips each having a length of about 1.5 millimeters, a width of about 15 millimeters and a thickness of about 100 micrometers. The carbon nanotubes were substantially aligned along the length (i.e., the 1.5 millimeter dimension) of the strips.

The carbon fiber tows and the carbon nanotube strips were assembled by hand in an orientation similar to that illustrated in FIG. 7A. In the assembled sample, the carbon fiber tows extended about 150 micrometers in the x-direction (referring to the coordinate axes illustrated in FIG. 7A), about 3 millimeters in the y-direction, and about 300 millimeters in the z-direction. In the assembled sample, the carbon nanotube strips extended about 100 micrometers in the x-direction, about 1.5 millimeters in the y-direction, and about 15 millimeters in the z-direction.

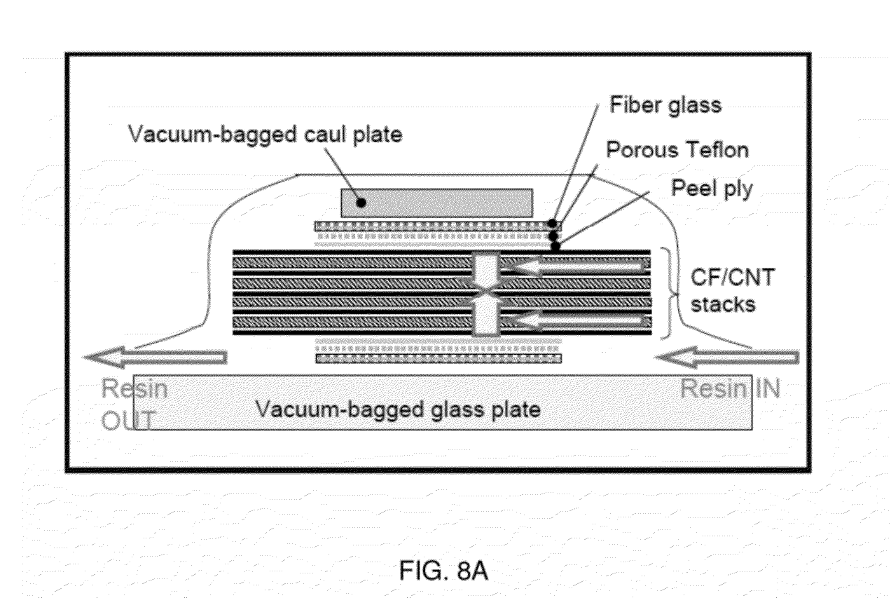

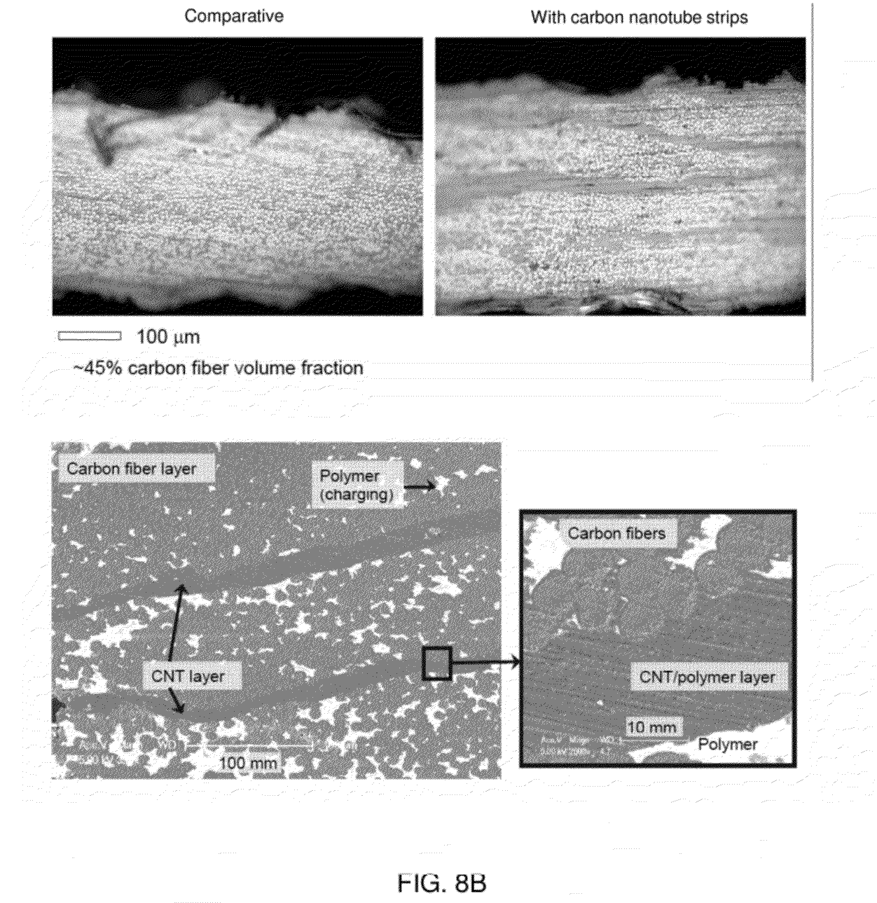

After assembly, the samples were put into a standard resin infusion setup and RTM6 epoxy was infused into the dry assembly, as shown in FIG. 8A. The specimens were then cured. Comparative samples were also made using a similar process, but without including the carbon nanotube strips.

Each sample was tested for simple DC electrical resistivity in several in-plane directions, similar to those described in Example 2. When measured in a direction orthogonal to the orientation of the carbon fibers, the samples including aligned carbon nanotube strips exhibited in-plane electrical resisitivities that were much lower than the in-plane resisitivities of the samples without aligned carbon nanotube strips. In addition, the through-thickness electrical conductivities of the samples (i.e., electrical conductivities along the x-axis in FIG. 7A) were measured. The samples including strips of carbon nanotubes exhibited electrical conductivities of about 9×10⁻² S/m, while the samples without the strips of aligned carbon nanotubes exhibited electrical conductivities of only about 3×10⁻² S/m.

Finally, SEM images of the samples were taken, as illustrated in FIG. 8B. The SEM images revealed the presence of the carbon nanotubes, and epoxy between the carbon nanotubes, in the final composites.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An article, comprising:
a plurality of fibers, wherein each of the plurality of fibers has a smallest cross-sectional dimension of at least about 1 micrometer, and the plurality of fibers has an average of the smallest cross-sectional dimensions; and
a plurality of elongated nanostructures arranged in association with the plurality of fibers to form a cohesive structure, wherein at least a portion of the elongated nanostructures have lengths of at least about 5 times the average of the smallest cross-sectional dimensions of the plurality of fibers.

2. An article, comprising:
a plurality of fibers, wherein each of the plurality of fibers has a smallest cross-sectional dimension of at least about 1 micrometer; and
a plurality of elongated nanostructures arranged in association with the plurality of fibers to form a cohesive structure such that all ends of at least about 50% of the elongated nanostructures are not in direct contact with any adjacent fibers.

3. An article, comprising:
a plurality of fibers, wherein each of the plurality of fibers has a smallest cross-sectional dimension of at least about 1 micrometer; and
a plurality of elongated nanostructures arranged in association with the plurality of fibers to form a cohesive structure such that the longitudinal axes of at least about 50% of the elongated nanostructures do not intersect any adjacent fibers.

4. An article, comprising:
a plurality of fibers, wherein each of the plurality of fibers has a smallest cross-sectional dimension of at least about 1 micrometer; and
a plurality of elongated nanostructures arranged in association with the plurality of fibers to form a cohesive structure such that the lengths of the elongated nanostructures span at least 2 fibers.

5. An article, comprising:
a first fiber having a smallest cross-sectional dimension of at least about 1 micrometer;
a second fiber having a smallest cross-sectional dimension of at least about 1 micrometer and a second longitudinal axis; and
an elongated nanostructure and/or a bundle of elongated nanostructures positioned between the first and second fibers such that the elongated nanostructure and/or assembly of elongated nanostructures are in contact with the first fiber and the second fiber.

6.-9. (canceled)

10. An article as in claim 1, wherein the fibers are arranged as tows of fibers.

11. An article as in claim 1, wherein the fibers are woven.

12. An article as in claim 1, wherein the elongated nanostructures are arranged as a plurality of strips of elongated nanostructures.

13. An article as in claim 1, wherein the fibers comprise carbon, Al₂O₃, SiO₂, glass, basalt, a cellulosic material, a metal, and/or a polymer.

14. An article as in claim 1, wherein the nanostructures comprise nanotubes, nanofibers, and/or nanowires.

15. An article as in claim 1, wherein the nanostructures comprise carbon-based nanostructures.

16. An article as in claim 15, wherein the carbon-based nanostructures comprise carbon nanotubes, carbon nanofibers, and/or carbon nanowires.

17. An article as in claim 1, wherein at least about 50% of the elongated nanostructures have an aspect ratio of at least about 10:1.

18. An article as in claim 1, wherein at least about 50% of the fibers have an aspect ratio of at least about 10:1.

19. An article as in claim 1, wherein the longitudinal axes of at least a portion of the elongated nanostructures are substantially aligned.

20. An article as in claim 1, wherein the longitudinal axes of at least a portion of the fibers are substantially aligned.

21. An article as in claim 1, wherein the smallest angle defined by the longitudinal axes of the aligned elongated nanostructures and the longitudinal axes of the adjacent aligned fibers is between about 45° and about 90°.

22. An article as in claim 1, wherein a binding material is present between the fibers, between the nanostructures, and/or between the fibers and the nanostructures.

23. An article as in claim 22, wherein the binding material comprises at least one of a monomer, a polymer, a ceramic, and a metal.

24. An article as in claim 23, wherein the binding material comprises at least one of an epoxy, a polyurethane, polyvinyl alcohol, and a silane.

25. An article as in claim 1, wherein the longitudinal axes of the elongated nanostructures are substantially straight.

26. An article as in claim 1, wherein the longitudinal axes of the elongated nanostructures are bent and/or curved.

27. An article as in claim 1, wherein the longitudinal axes of the fibers are substantially straight.

28. An article as in claim 1, wherein the longitudinal axes of the fibers are bent and/or curved.

29. An article as in claim 1, wherein at least about 50% of the elongated nanostructures include longitudinal axes arranged such that the majority of the lengths of the longitudinal axes are tangential to the fibers with which the elongated nanostructures are in contact.

30. An article as in claim 5, wherein the elongated nanostructure and/or bundle of elongated nanostructures are in direct contact with the first fiber and the second fiber.

31. An article as in claim 5, wherein a longitudinal axis of at least one of the elongated nanostructures is substantially parallel to the longitudinal axis of the first fiber and/or the longitudinal axis of the second fiber.

32. An article as in claim 5, wherein the longitudinal axis of the first fiber is substantially orthogonal to the longitudinal axis of the second fiber.

33. An article as in claim 5, wherein the first fiber and the second fiber are part of a woven fabric or a non-woven fabric.
